(19) United States
(12) Patent Application Publication
(10) Pub. No.: US 2010/0283750 A1
(43) Pub. Date: Nov. 11, 2010

(54) METHOD FOR PROVIDING INTERFACE

(75) Inventors: Tae Young KANG, Gyeonggi-do (KR); Min Kyu PARK, Gyeonggi-do (KR); Yong Gook PARK, Gyeonggi-do (KR); Hyun Jin KIM, Seoul (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/756,270

(22) Filed: Apr. 8, 2010

(30) Foreign Application Priority Data
May 6, 2009 (KR) 10-2009-0039226

(51) Int. Cl. G06F 3/041; G06F 3/048

(52) U.S. Cl. 345/173; 715/769

(57) ABSTRACT

Disclosed is a method for providing an interface which is performed in a touch interface including: sensing a first touch input at a first position; sensing a second touch input at a second position which is a different position from the first position when the first touch input is continuously sensed; and displaying a selection area after sensing the first touch input and the second touch input.

### CLAIM OF PRIORITY

This application claims the benefit under 35 U.S.C. §119(a) of a Korean patent application filed in the Korean Intellectual Property Office on May 6, 2009 and assigned Serial No. 10-2009-0039226, the entire disclosure of which is hereby incorporated by reference.

### BACKGROUND OF THE INVENTION

1. Field of the Invention

The present invention relates to a method and apparatus for providing an interface, and more particularly, to a method and apparatus for an interface which is appropriate for a large-sized touch screen.

2. Description of the Related Art

A user interface refers to an action or a device that transmits necessary information to the user and reflects the user's opinion to a system through a control panel of a computer, an electronic appliance or a large-scale system.

A user interface includes an input device selected from the group consisting of a keyboard, a mouse, a touch pad and a track ball, and an output device selected from the group consisting of a monitor and a printer. Recently, a touch screen which plays both roles of an input device and an output device has come into wide use.

A touch screen can be implemented by a transparent film-shaped input device as a covering on a display. Some examples of a method for implementing a touch screen are a method for determining a location by arranging detection lines in a lattice shape, a method for detecting a change of electrical charges contained in a film, and a method for determining a location by blocking one of infrared rays and ultrasonic waves which are made to flow in a lattice shape. The touch screen comprises a touch panel, a controller which controls a signal of the touch panel and is connected to a personal computer to transmit and receive data, and various kinds of software which are necessary for the system. The precision of the touch screen is not so high, but a keyboard is not necessary and operation is simple so that the touch screen is widely used in ATMs and as an information retrieval system of a subway station and shopping mall kiosks. In addition, the touch screen is used for medical examination, patient monitoring, prescription management and medical recording in a hospital and a laboratory, and is also used for education of children and disabled persons. In addition, the touch screen can be applied to an unmanned ticketing system and a business administration system. As a touch screen is widespread and recently a large-sized display has been manufactured, a method for providing a touch screen function in a large-sized display has become an issue.

In a general display, the user can touch the entire screen, but in case of a large-sized display, the user's finger may not reach a certain portion of the screen depending on the user's position, and it may be difficult for the user to touch the screen, so that the user can feel inconvenienced in a general method for touching a screen.

### SUMMARY OF THE INVENTION

The present invention provides a touch interface which is convenient for a user to use to interact with a large-sized display.

An exemplary embodiment of the present invention is a method for providing an interface which is performed in a touch interface and includes: sensing a first touch input at a first position; sensing a second touch input at a second position which is a different position from the first position when the first touch input is continuously sensed; and displaying a selection area after sensing the first touch input and the second touch input.

In another exemplary embodiment of the present invention is a method for providing an interface which is performed in a touch interface and includes: sensing three or more touch inputs comprising a first touch input, a second touch input and a third touch input, wherein the first touch input is sensed at a first touch sensing position, the second touch input is sensed at a second touch sensing position, the third touch input is sensed at a third touch sensing position, and the first touch sensing position, the second touch sensing position and the third touch sensing position are arranged at different positions; and displaying a first selection area surrounded by a boundary line comprising boundary positions which correspond to the touch sensing positions at which the three touch inputs are sensed

### BRIEF DESCRIPTION OF THE DRAWINGS

The above and other features and advantages of certain exemplary embodiments of the present invention will be more apparent from the following description taken in conjunction with the accompanying drawings, in which:

FIG. 1 illustrates a block diagram of a touch interface device 100 according to an exemplary embodiment of the present invention;

FIG. 2 illustrates a touch interface screen 200 according to an exemplary embodiment of the present invention;

FIG. 3 illustrates a touch interface screen 300 according to an exemplary embodiment of the present invention;

FIG. 4 illustrates a flowchart 400 of a process for displaying a selection area 360 according to an exemplary embodiment of the present invention;

FIG. 5 illustrates a flowchart 401 of a process for displaying a selection area 360 according to another exemplary embodiment of the present invention;

FIG. 6 illustrates a touch interface screen 600 according to another exemplary embodiment of the present invention;

FIG. 7 illustrates a screen 700 for providing a touch interface according to an exemplary embodiment of the present invention;

FIG. 8 illustrates a process for displaying a touch interface screen according to an exemplary embodiment of the present invention;

FIG. 9 illustrates a flowchart of a process for displaying a touch interface screen according to an exemplary embodiment of the present invention;

FIGS. 10a to 10d illustrate a process for moving a selection area according to an exemplary embodiment of the present invention;

FIG. 11 illustrates a flowchart 1100 of a process for moving a selection area according to an exemplary embodiment of the present invention;

FIGS. 12a to 12d illustrate a process for changing a selection area direction according to an exemplary embodiment of the present invention;

FIG. 13 illustrates a flowchart 1300 of a process for moving a selection area according to an exemplary embodiment of the present invention;

FIG. 14 illustrates a method for moving a selection area according to another exemplary embodiment of the present invention;

FIGS. 15a to 15d illustrate a process for changing the size of a selection area according to an exemplary embodiment of the present invention;

FIG. 16 illustrates a flowchart 1600 of a process for changing the size of a selection area according to an exemplary embodiment of the present invention;

FIGS. 17a and 17b illustrate a process for selecting contents according to an exemplary embodiment of the present invention;

FIG. 18a illustrates a process for moving an item according to an exemplary embodiment of the present invention;

FIGS. 18b and 18c illustrate a process for selecting and moving an item according to an exemplary embodiment of the present invention;

FIGS. 19a to 19d illustrate a process for displaying an option window 1950 according to an exemplary embodiment of the present invention;

FIG. 20 illustrates a flowchart of a method for displaying a selection area and a touch sensing area according to an exemplary embodiment of the present invention;

FIG. 21a illustrates a touch interface screen according to an exemplary embodiment of the present invention;

FIG. 21b illustrates a touch interface screen according to another exemplary embodiment of the present invention;

FIG. 22 illustrates a flowchart 2200 of a method for displaying a touch interface according to an exemplary embodiment of the present invention;

FIG. 23 illustrates a flowchart of a process for providing an interface according to an exemplary embodiment of the present invention;

FIGS. 24a to 24d illustrate a process for moving a selection area according to an exemplary embodiment of the present invention;

FIGS. 25a and 25b illustrate a process for selecting an item according to an exemplary embodiment of the present invention;

FIG. 26 illustrates a process for moving an item according to an exemplary embodiment of the present invention;

FIG. 27 illustrates a process for moving a selection area according to an exemplary embodiment of the present invention;

FIG. 28 illustrates a process for providing a touch interface according to an exemplary embodiment of the present invention;

FIGS. 29a to 29c illustrate a process for providing a touch interface according to an exemplary embodiment of the present invention; and

FIG. 30 illustrates a process for providing a touch interface according to an exemplary embodiment of the present invention.

### DETAILED DESCRIPTION OF THE INVENTION

Exemplary embodiments of the present invention are described in detail with reference to the accompanying drawings. The same reference numbers are used throughout the drawings to refer to the same or like parts. For the purposes of clarity and simplicity, detailed descriptions of well-known functions and structures incorporated herein may be omitted to avoid obscuring the subject matter of the present invention.

The meaning of terms is clarified in this disclosure, so the claims should be read with careful attention to these clarifications. Specific examples are given, but those of skill in the relevant art will understand that other examples may also fall within the meaning of the terms used, and within the scope of one or more claims. Terms do not necessarily have the same meaning here that they have in general usage, in the usage of a particular industry, or in a particular dictionary or set of dictionaries. In the event of an irresolvable conflict between a term's meaning as used expressly herein and the term's meaning as used in an incorporated document, the express meaning herein governs. Although this disclosure and the associated drawings fully detail several alternate exemplary embodiments of the present invention, further alternate embodiments can be implemented without departing from the scope of this invention. Consequently, it is to be understood that the following disclosure is provided for exemplary purposes only and is not intended as a limitation of the present invention. Furthermore, all alternate embodiments which are obvious modifications of this disclosure are intended to be encompassed within the scope of the present invention.

Hereinafter, a method for providing an interface according to exemplary embodiments of the present invention is illustrated with reference to attached drawings.

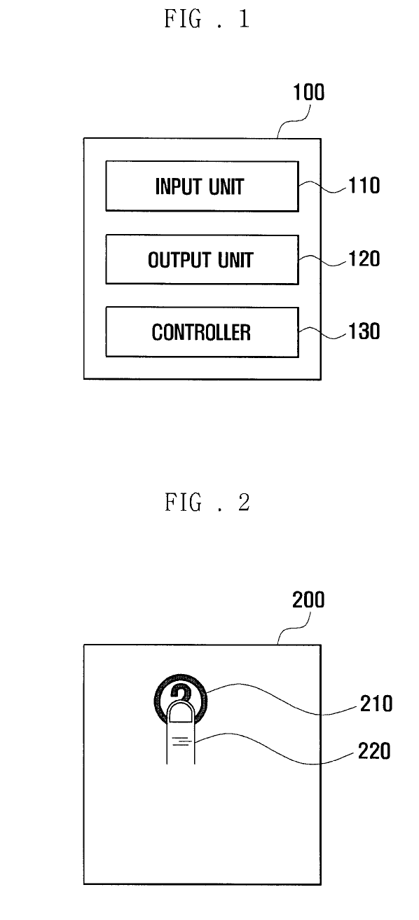

FIG. 1 illustrates a block diagram of a touch interface device 100 according to an exemplary embodiment of the present invention.

Referring to FIG. 1, a touch interface device according to an exemplary embodiment of the present invention includes an input unit 110, an output unit 120, and a controller 130.

The input unit 110 receives a user's touch input, converts the user's touch input into an electrical signal, and transmits the electrical signal to the controller 130. An electrical signal according to a touch input can be different according to any of the characteristics including the position of the touch and the intensity of the touch. The input unit 110 according to an exemplary embodiment of the present invention can be implemented in such a manner that a touch sensor is included in a display portion of the output unit 120. The input unit 110 according to an exemplary embodiment of the present invention can sense at least two touch inputs which are simultaneously inputted, and can sense any of the types including a touch, a drag, a drag & drop, a flip, a flick, a click, and a double click.

According to another exemplary embodiment of the present invention, the input unit 110 can sense only some of the types including a drag, a drag and drop, a flip, a flick, a click and a double click.

Since the method for sensing a touch input and converting a touch input into an electrical signal is well-known, it is omitted here. The controller 130 can receive an electric signal converted from a touch input from the input unit 110, change the display of the output unit 120 according to the electric signal, and perform other processes.

FIG. 2 illustrates a touch interface screen 200 according to an exemplary embodiment of the present invention.

For example, if an input unit 110 senses a touch input 220 in the position of an item 210 on a screen 200, the input unit 110 converts the touch input 220 into an electrical signal and transmits the electrical signal to the controller 130, and the controller 130 can execute an item 210, and output the result of the execution through the output unit 120.

According to another exemplary embodiment of the present invention, if the input unit 110 senses a double click input in the position of the item 210, the result of the execution can be outputted through the output unit 120.

The output unit 120 receives an output signal transmitted from the controller 130, and outputs a screen according to the output signal. The output unit 120 can be implemented in various methods including any of an LCD and an LED. The input unit 110 must be able to sense a touch of a screen, so that a touch sensor of the input unit 110 can be installed close to the screen of the output unit 120. For example, the input unit 110 and the output unit 120 can be implemented by a touch screen method.

The present invention includes a rake-type interface and an umbrella-type interface. First, a rake-type interface is explained.

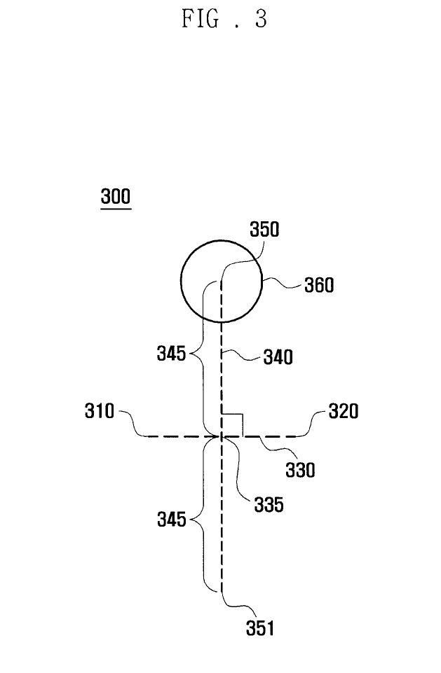

FIG. 3 illustrates a touch interface screen 300 according to an exemplary embodiment of the present invention.

Referring to FIG. 3, a touch interface senses a touch input in a first position 310 and a second position 320. In this case, a straight line 340, which passes the middle point of a segment 330 that connects the first position 310 with the second position 320, and is perpendicular to the segment 330, can be drawn. A third position 350 is set in a position which exists on a straight line 340 and is separately positioned from the segment by a preset distance 345, and the touch interface displays a selection area 360 including a third position 350. The selection area 360 is outputted on the screen 300, but the segment 330, the straight line 340, the first position 310, the second position 320, the third position 350 and the middle point 335 of the segment 330 do not necessarily need to be outputted.

If an item contacts the selection area 360, the item becomes selectable, and can be one of selected and moved according to a touch input, and the item can be executed, which will be described later.

According to an exemplary embodiment of the present invention, the selection area 360 can be displayed only in case an input in the first position 310 and an input in the second position 320 occur at the same time, that is, a touch input is sensed in the second position 320 while a touch input is continually sensed in the first position 310.

According to another exemplary embodiment of the present invention, the selection area 360 can be displayed not only in case a touch input is sensed in the second position 320 while a touch input is continually sensed in the first position 310, but also in case a touch input is sensed in a second position 320 which is different from a first position within a given time (e.g., 10 seconds) after the input is terminated in the first position 310.

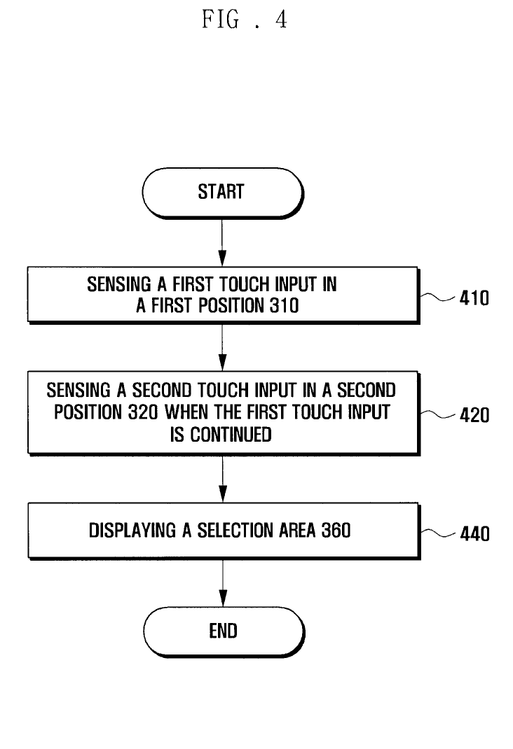

FIG. 4 is a flowchart 400 illustrating a process for displaying a selection area 360 according to an exemplary embodiment of the present invention.

A touch interface senses a first touch input in a first position 310 (410). The touch interface senses a second touch input in a second position 320 (420). The first position 310 and the second position 320 should be different positions. Actually, the first position 310 and the second position 320 must be away from each other in such a manner that the touch interface can recognize the first position 310 and the second position 320 as different positions. According to an exemplary embodiment of the present invention, only in case the distance between the first position 310 and the second position 320 is within a preset range (e.g., 5 cm or more and less than 10 cm), two touch inputs are considered to be sensed, and the selection area 360 can be displayed. In addition, when a second touch input is sensed, the first touch input must be continually sensed. The touch interface displays a selection area 360 (440). The selection area 360 is displayed in case the first touch input is continually sensed when the second touch input is sensed, that is, the first touch input and the second touch input are simultaneously sensed.

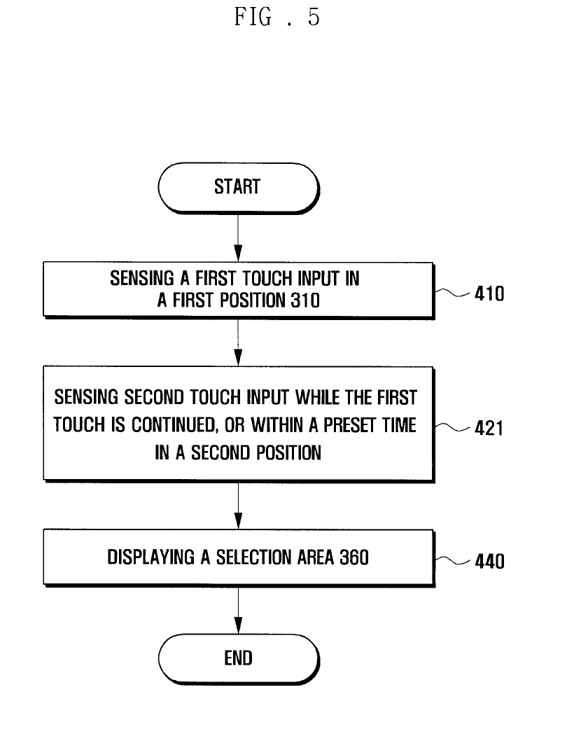

FIG. 5 illustrates a flowchart 401 of a process for displaying a selection area 360 according to another exemplary embodiment of the present invention. Items 410 and 440 have been already explained with reference to FIG. 4. One of the second touch input is sensed while the first touch is continually sensed, and the second touch input is sensed within a preset time (e.g., 3 seconds) after the sensing of the first touch input is terminated (421). That is, one of the second touch input is sensed while the first touch input is continually sensed, and the second touch input is sensed within 3 seconds after the sensing of the first touch input is terminated. However, in case a touch input is sensed at least 3 seconds later after the sensing of the first touch input is terminated, the touch input is considered a first touch input. Thus, in such a case, the second input is not sensed.

Actually, the first touch input and the second touch input are sensed, practically not in the same point, but in a specific area. The first position 310 can be, for example, a position corresponding to the center of gravity in an area where the first touch input is sensed. Depending on the exemplary embodiments, another position can be a first position 310 in an area where the first touch input is sensed.

According to an exemplary embodiment of the present invention, the selection area 360 is set to include a third position 350. As illustrated by the exemplary embodiment of FIG. 3, the third position 350 is positioned on a straight line 340 which is perpendicular to a segment 330 which connects a first position 310 with a second position, and passes the middle point of the segment 330, and the distance between the third position 350 and the middle point 335 of the segment 330 can be set to be a preset distance (e.g., 10 cm). If the preset distance is 0, the third position becomes the middle point 335 of the segment 330.

In case the preset distance is not 0, the third position 350 can be one of a point 350 and a point 351 as illustrated in FIG. 3. According to an exemplary embodiment of the present invention, any one of the point 350 and the point 351 can be arbitrarily selected as the third position.

According to another exemplary embodiment of the present invention, a point which is further from the edge of the entire screen 300 among the two points of the point 350 and the point 351 can be selected as the third position because it is more convenient to start from a further point from the edge in controlling a remote item considering the purpose of the present invention.

According to an exemplary embodiment of the present invention, the selection area 360 can be, for example, a circle with the third point 350 as the center. In this case, the diameter of the selection area 360 can be set to be the same as the length of the segment 330. According to another exemplary embodiment of the present invention, the selection area 360 can be made in a plurality of shapes including a quadrangle, an oval, a triangle, and any other polygon including a pentagon according to one of a user setting and manufacturer setting.

For example, if the selection area 360 is a circle, the diameter of the selection area 360 can be a preset length (e.g., 3 cm). In addition, according to another exemplary embodiment of the present invention, the length of the diameter of the selection area 360 can be one of the length of the segment multiplied by a preset value (e.g., 2) and an output value of a function when the length of the segment 330 is an input of the function. For example, when the length of the diameter of the selection area 360 is the length of the segment 330 multiplied by 2, if the length of the segment 360 is 3 cm (that is, the distance between two touch inputs is 3 cm), the diameter of the selection area 360 can be 6 cm. According to another exemplary embodiment of the present invention, when the length (x) of the segment 330 is an input of f(x)=1+x^{1/2}, f(x) becomes the length of the diameter of the segment 360. That is, if the length of the segment 330 is 4 cm, f(4)=3, so that the diameter of the segment 360 becomes 3 cm.

The selection area 360 is displayed to distinguish an area which belongs to the selection area 360 and an area which does not belong to the selection area 360. As illustrated in FIG. 3, one of a boundary line between the selection area 360 and the area which is not the selection area can be displayed, and the selection area 360 can be displayed by a specific color (e.g., red). According to another exemplary embodiment of the present invention, the color of the selection area 360 can be displayed by inverting one of the color of the selection area 360, and brightness, chroma, and color of the selection area 360 can be changed by a pre-determined method, and then be displayed.

According to another exemplary embodiment of the present invention, the segment 330 and the straight line 340 of FIG. 3 can cross at different points on the segment 330 instead of the middle point 335 of the segment 330.

In addition, according to another exemplary embodiment of the present invention, the segment 330 and the straight line 340 of FIG. 3 may not cross at right angles, but can form a preset angle (e.g., 80°). If the angle is close to 0° or 180°, provision of an intuitive interface is difficult, so that it would be appropriate to set the angle between the segment 330 and the straight line 340 as between 80° and 100° or between 85° and 95°. Particularly, it is possible to allow user setting of the angle between the segment 330 and the straight line 340 in consideration of the length difference of user fingers (an index finger and a middle finger).

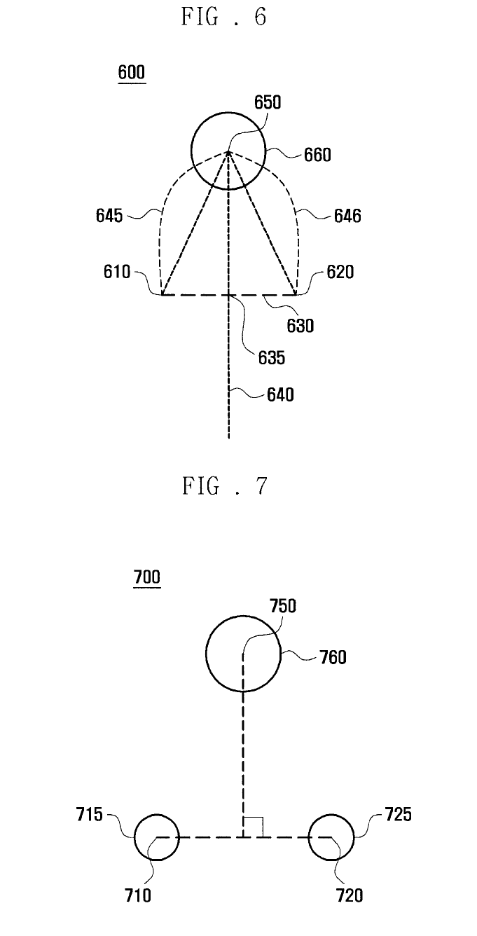

FIG. 6 illustrates a touch interface screen 600 according to another exemplary embodiment of the present invention.

It is assumed that a touch input is sensed in a first position 610 and a second position 620. In this case, a third position 650 can be determined as a position which is separately positioned from the first position 610 by a first preset distance 645, and is separately positioned from the second position by a second preset distance 646.

According to an exemplary embodiment of the present invention, a first setting distance 645 and a second setting distance 646 can be determined as a given value according to one of a user setting, and can be determined according to the setting when the touch interface is manufactured.

According to another exemplary embodiment of the present invention, the first setting distance 645 and the second setting distance 646 can be changed according to the length of the segment 630 which connects the first position 610 with the second position 620. For example, the first setting distance 645 and the second setting distance 646 can be set to be the same as the length of the segment 630. In this case, a triangle formed by the first position 610, the second position 620 and the third position 650 becomes an equilateral triangle.

In case the first setting distance 645 and the second setting distance 646 are the same, the third position 650 is located on the straight line 640 which passes the middle point of the segment that connects the first position 610 with the second position 620, and is perpendicular to the segment 630.

That is, the third position 650 can be set by one of the first setting distance 645 and the second setting distance 646, and can be set by the position of the intersection point between the segment 620 and the straight line 630, the angle formed by the segment 620 and the straight line 630 and the distance from the intersection point between the segment 620 and the straight line 630 to the third position 650.

The first setting distance 645 and the second setting distance 646 must be set to be the same in order for the third position 650 to be set to be located on the straight line 640 which passes the middle point 635 of the segment 630 and is perpendicular to the segment 630.

According to another exemplary embodiment of the present invention, the ratio of the first setting distance 645 to the second setting distance 646 can be set to be within a preset ratio range (e.g., 9/10 or more and 10/9 or less). In this case, the third position 650 is located around the straight line 640.

FIG. 7 illustrates a screen 700 for providing a touch interface according to an exemplary embodiment of the present invention.

Referring to FIG. 7, a touch interface senses a first touch input in a first position 710, senses a second touch input in a second position 720, and displays a selection area 760 including a third position 750. In the exemplary embodiment of FIG. 7, the touch interface displays a first area 715 including the first position 710 and a second area 725 including the second position 720. If the first touch input is sensed in the first position 710, the first area including the first position 710 is displayed, and if the second touch input is sensed in the second position 720, the second area 725 including the second position is displayed. That is, if a touch input is sensed, the area around the touched position is distinguished from other areas, and is displayed.

Since the method for displaying the first area 715 and the second area 725 is similar to the method for displaying a selection area illustrated with reference to FIG. 3, the detailed explanation is omitted here.

The display of the first area 715, the second area 724 and the selection area 760 can be performed independently of each other. For example, the first area 715 and the second area 725 can be displayed using a red rim, and the entire selection area 760 can be colored and displayed by a blue color.

According to another exemplary embodiment of the present invention, the display of the first area 715, the second area 725 and the selection area 760 can be done all in the same manner. For example, the entire area of the first area 715, the second area 725 and the selection area 760 can be colored in red and displayed.

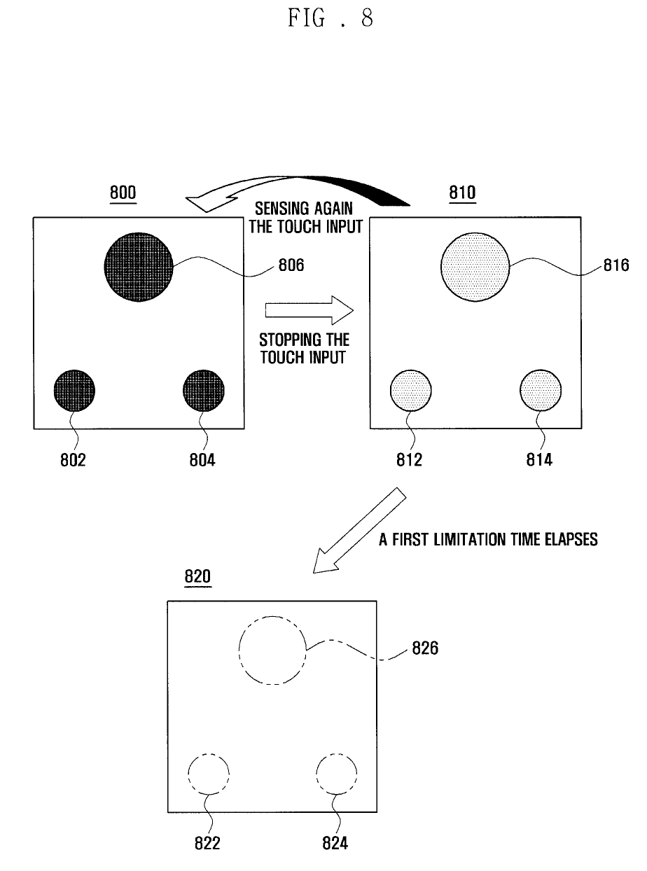

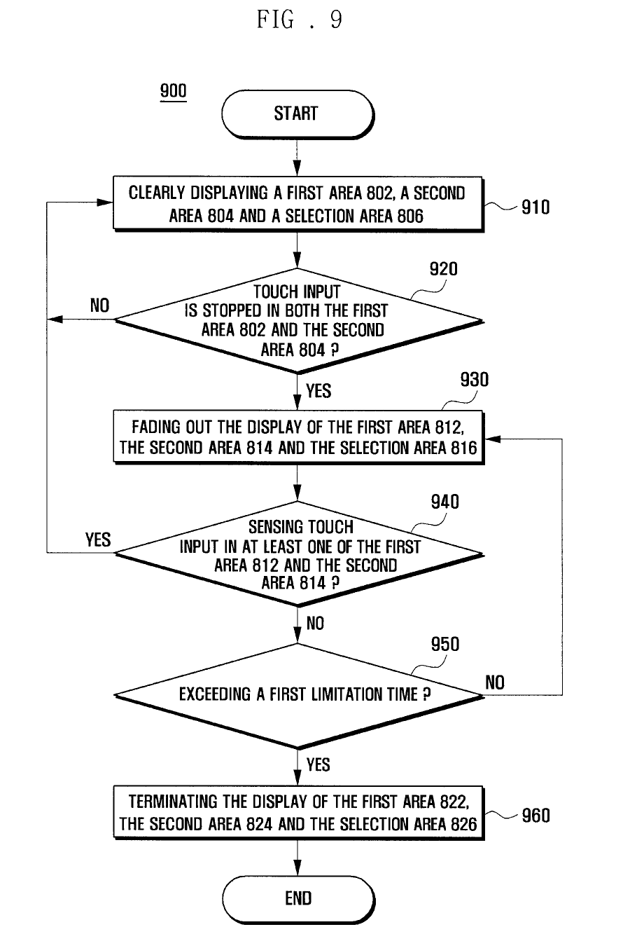

FIG. 8 illustrates a process for displaying a touch interface screen according to an exemplary embodiment of the present invention, and FIG. 9 illustrates a flowchart of a process for displaying a touch interface screen according to the exemplary embodiment of the present invention. A touch interface senses a first touch input in the first area 802, and senses a second touch input in the second area 804. A first screen 800 is a screen right after the first touch input and the second touch input are sensed. The first screen shows that the first area 802 where the first touch input is sensed, the second area 804 where the second touch input is sensed, and the selection area 806 according to the first touch input and the second touch input are displayed in relatively dark black. Such display does not necessarily need to be black, but it requires only to be clear. A detailed method for displaying the first area 802, the second area 804 and the selection area 806 can be variously set as explained above with reference to FIGS. 3 and 7, but it is assumed that the first area 802, the second area 804 and the selection area 806 are displayed in dark black.

It is determined whether the touch input is stopped in both the first area 802 and the second area 804 (920). If a user finger is taken off both the first area 802 and the second area 804, the touch input is stopped in both the first area 802 and the second area 804, but the touch input is continually sensed if the user finger keeps touching one of the first area 802 and the second area 804.

If the touch input is continually sensed, a clear display is continued as illustrated by the first screen 800 at step 910.

In case the touch input is not sensed, the touch interface fades out in the display of the first area 812, the second area 814 and the selection area 816 as shown in the second screen 810 (930). Here, the position and the size of the first area 812, the second area 814 and the selection area 816 are the same as the position and the size of the first area 802, the second area 804 and the selection area 806 of the first screen 800, but different reference numerals are used because the first area 812 and the second area 814 and the selection area 816 are less clear than the first area 802, the second area 804 and the selection area 806.

That is, the touch interface makes the display of each area gradually dull. In the embodiment of FIG. 8, the display of the first area 812, the second area 814 and the selection area 816 are all faded out, but according to another exemplary embodiment of the present invention, the display of one of one and two areas of the first area 812, the second area 814 and the selection area 816 can be faded out. It is assumed here that the display of the first area 812, the second area 814 and the selection area 816 are all faded out as shown in FIG. 8 for the convenience of illustration.

The fade-out method can be different depending on the display method for each area. In case only the rim of the area is displayed, the color of the rim can be implemented to gradually change to get close to the background color. In case the entire area is displayed, the color of the entire area can be implemented to gradually change to get close to the background color. Since the fade-out processing method is a well-known technology, the detailed explanation is omitted here.

It is determined whether a touch input is sensed in at least one of the first area 812 and the second area 814 (940).

If a touch input is sensed, returning to step 910, the first area 802, the second area 804 and the selection area 806 are clearly displayed as in the first screen 800.

If a touch input is not sensed, it is determined whether a time that the touch input was not sensed exceeded a first preset limitation time (950).

The first limitation time can be set according to one of user setting and a software provider setting and a touch interface manufacturer.

For example, the first limitation time can be 10 seconds.

If the first limitation time is 10 seconds, the display of the first area 812, the second area 814 and the selection area 816 is gradually faded out while repeating steps 930 to 950, and then, if 10 seconds pass, the display of the first area 822, the second area 824 and the selection area 826 is terminated (960).

In case the time during when the touch input is not sensed does not exceed the first limitation time, step 930 is executed, and each of the first and second area is faded out, and then, step 940 and step 950 are repeated.

In case the time during when the touch input is not sensed exceeds the first limitation time, the display of the first area 822, the second area 824 and the selection area 826 is terminated after returning to step 960. Here, the location and the size of the first area 822, the second area 824 and the selection area 826 are the same as the location and the size of the first area 802, the second area 804 and the selection area 806, but different reference numerals are used because the display of the first area 822, the second 824 and the selection area 826 disappears.

If the first limitation time passes while user does not touch any of the first area 822 and the second area 824, it is determined that user does not have a desire to maintain the selection area, so that the display of the first area 822, the second area 824 and the selection area 826 is stopped. Thereafter, the selection area can be displayed only when two new touch inputs are sensed as illustrated in FIG. 3 or FIG. 7.

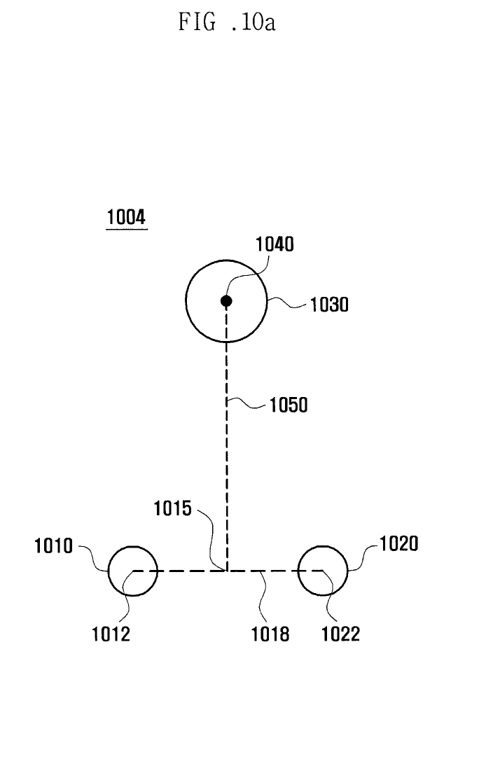

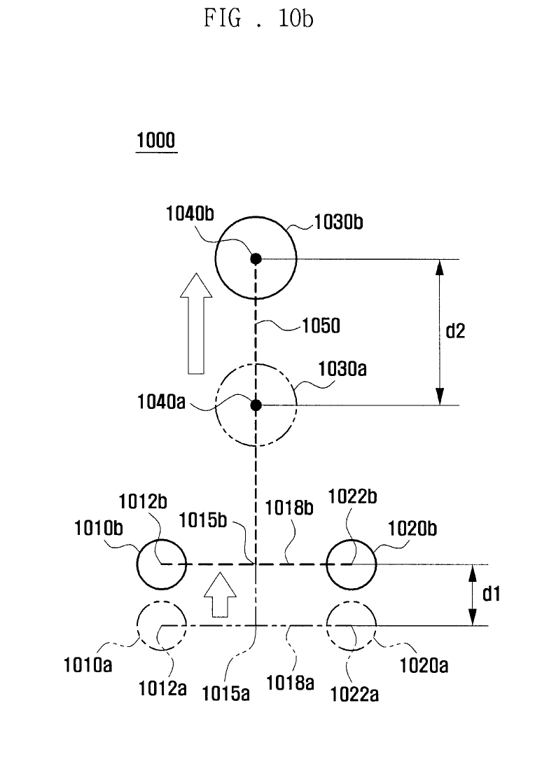

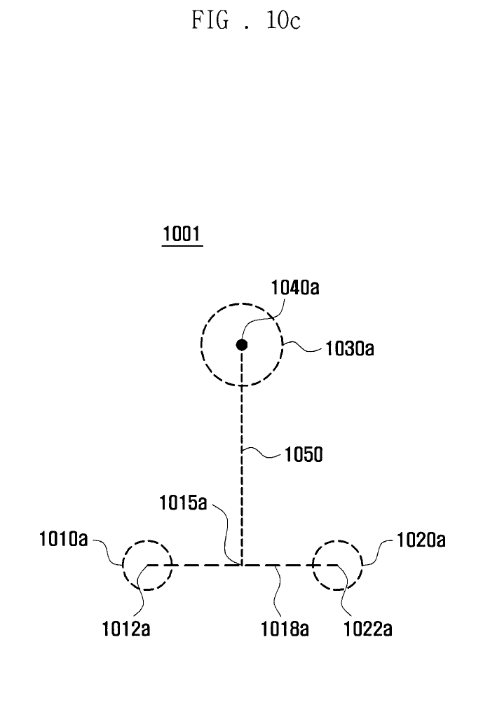

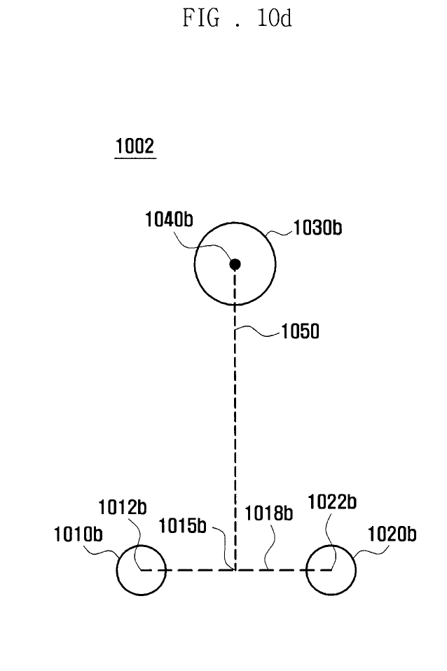

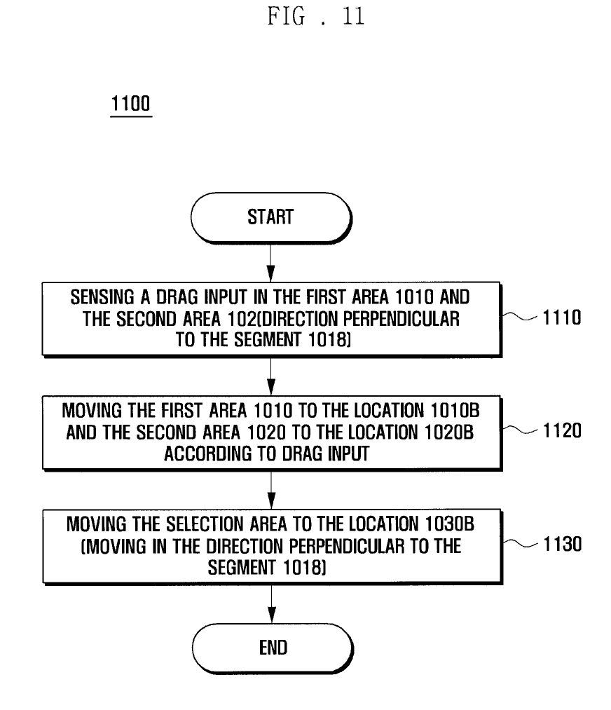

FIGS. 10a to 10d illustrate a process for moving a selection area according to an exemplary embodiment of the present invention.

FIG. 10a illustrates a display of a selection area according to an exemplary embodiment of the present invention (1004).

FIG. 10b illustrates both before and after a drag input is sensed (1000), FIG. 10c illustrates before a drag input is sensed (1001), and FIG. 10d illustrates after a drag input is sensed (1002).

FIG. 11 is a flowchart 1100 illustrating a process for moving a selection area according to an exemplary embodiment of the present invention.

Referring to FIG. 10a, a first touch point 1012 is a point where a touch is lastly inputted in a first area 1010, and the first area 1010 is a type of a circle with the first touch point 1012 as the center.

A second touch point 1022 is a point where a touch is lastly inputted in a second area 1020, and the second area 1020 is a type of a circle with the second touch point 1022 as the center.

The selection area 1030 is a type of a circle with the selection reference point 1040 as the center.

A segment 1018 is a segment which connects the first touch point 1012 with the second touch point 1022, and a straight line 1050 is a straight line which is perpendicular to the segment 1018 in the middle point 1015 of the segment.

The selection reference point 1040 moves on the straight line 1050.

Referring to FIGS. 10b, 10b and 11, before step 1110, the first area 1010 is circle 1010a with a first position 1012a, which is the current position of the first touch point 1012, as the center, the second area 1020 is a circle with a second position 1022a, which is the current position of the second touch point 1022, as the center, and the selection area 1030 is a circle with a fifth position, which is the current position of the selection reference point 1040a, as the center. Each area before step 1110 is represented by dotted lines. The fifth position 1040a is positioned on a straight line 1050 which passes the middle point 1015a of a segment 1018a which connects the first position 1012a with the second position 1022a, and is perpendicular to the segment 1018a, and is separately positioned from the middle point 1015a by a given distance k.

A touch interface senses a drag input in the first area 1010 and the second area 1020 (1110).

A drag input in the first area 1010 is started in the first position 1012a and is continued to a third position 1012b, and the drag input in the second area 1020 is started in the second position 1022a and is continued to a fourth position 1022b.

If user pushes up his two fingers while the two fingers contact the touch interface, the touch interface can sense a drag input at step 1110.

Referring to FIGS. 10b and 10d, the touch interface moves the first area 1010 and the second area 1020 to include the last position of the drag input in the first area 1010 and the second area 1020 (1120).

As described above, since the drag input of the first area 1010 was continued to the third position 1012b, the touch interface moves the first area 1010 to the position of reference numeral 1010b including the third position 1012b.

In addition, since the drag input of the second area 1020 was continued to the fourth position 1022b, the touch interface moves the second area 1020 to the position of reference numeral 1020b including the fourth position 1022b.

The touch interface moves and displays the selection area 1030 (1130).

The first touch point 1012 is moved from the first position 1012a to the third position 1012b according to a drag input, and the second touch point 1022 is moved from the second position 1022a to the fourth position 1022b according to a drag input.

As the first touch point 1012 and the second touch point 1022 are moved, the segment 1018 which connects the first touch point 1012 with the second touch point 1022 is also moved from the position of reference numeral 1018a to the position of reference numeral 1018b, and the middle point 1015 of the segment 1018 is also moved from the position of reference numeral 1015a to the position of reference numeral 1015b.

Assuming that a distance that the first touch point 1012 and the second touch point 1022 moved in a direction that is perpendicular to the segment 1018 is d1, the distance that the middle point 1015 of the segment 1018 moved in a direction that is perpendicular to the segment 1018 is also d1.

The touch interface moves a selection reference point 1040 in a direction that is perpendicular to the segment 1018 by d2 which is a distance having a positive correlation with d1 which is a distance that the middle point 1015 of the segment 1018 moved in a direction that is perpendicular to the segment 1018.

Before step 1110, the selection reference point 1040 is positioned in the fifth position 1040a as described above. In addition, since the middle point 1015 of the segment 1018 moved by d1, the selection reference point 1040 is positioned in the position of reference numeral 1040b by moving in a direction that is perpendicular to the segment 1018 by d2. The selection area 1030 also moves to the position of reference numeral 1030b as the selection reference point 1040 moves.

d1 and d2 have a positive correlation. For example, the relation can be d2=d1×c (c is a constant of 1 or more). Assuming that c is 10, when the middle point 1015 of the segment 1018 moves by 2 cm (or 20 pixels), the selection reference point 1040 moves by 20 cm (or 200 pixels) and accordingly the selection area 1030 also moves.

According to exemplary embodiments illustrated in FIGS. 10a to 10d and 11, even in case user drags the first area 1010 and the second area 1020 by a short distance, the selection area 1040 can move a long distance, so that user can move the selection area 1040 in order for an item at a long distance to be selected even by a little bit of finger movement.

According to another exemplary embodiment of the present invention, as the middle point 1015 of the segment 1018 continually moves, the selection reference point 1040 can be made to move at slow speed at first, and gradually move faster. That is, for the same distance moved by the middle point 1015, the selection reference point 1040 can be set to move by 10 cm for the first 1 second, and to move by 20 cm for the consecutive next one second, as an example.

In the explanation with reference to FIGS. 10a to 10d and 11, only the movement in a direction that is perpendicular to the segment 1018 of the middle point 1015 of the segment 1018 was explained.

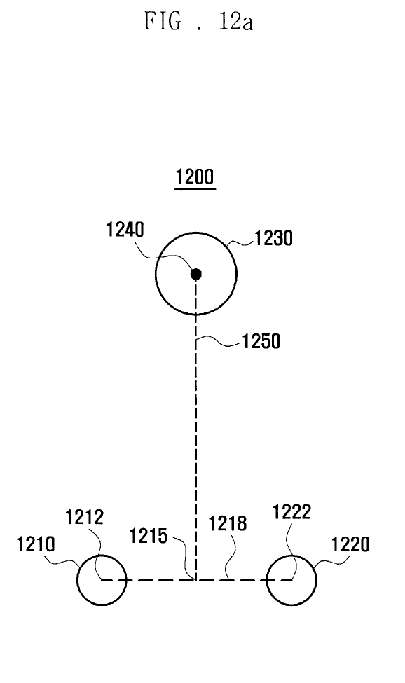

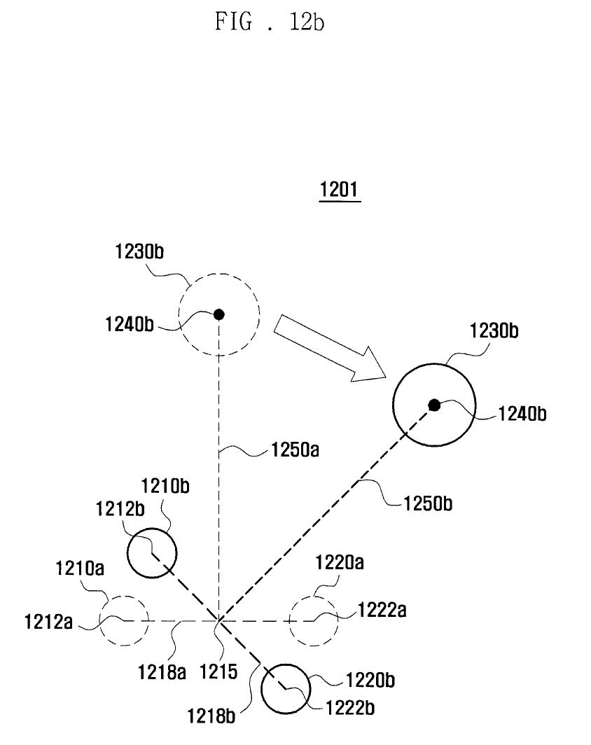

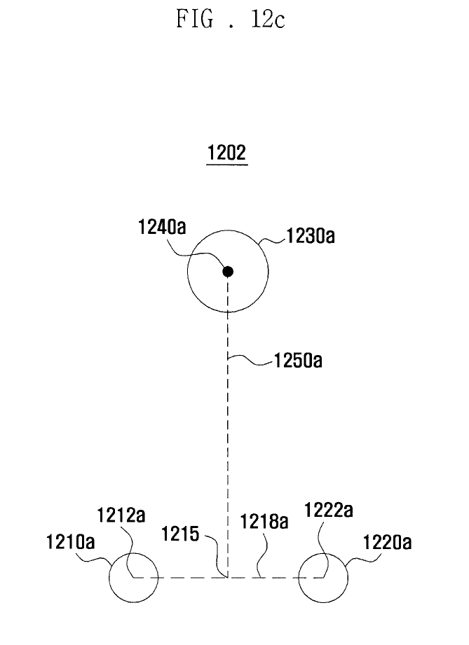

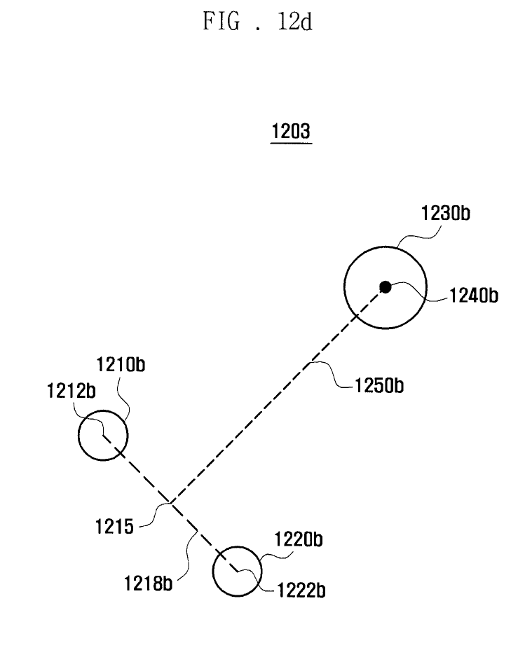

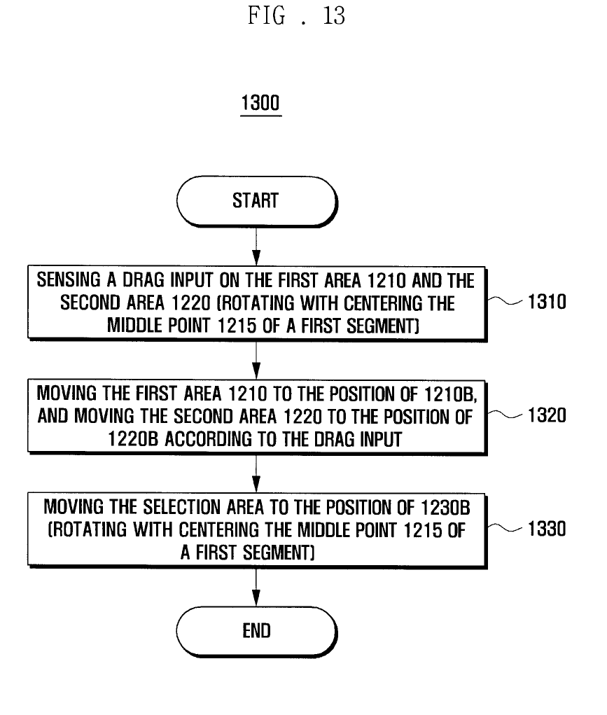

Likewise, the movement in a segment 1018 direction of the middle point 1015 of the segment 1018 can cause the movement of the selection area 1030. In this case, likewise, the selection area 1030 can be moved by a moving distance having a positive correlation with the moving distance of the middle point 1015 of the segment 1018. Only, in case the middle point 1015 of the segment 1018 moves in a segment 1018 direction, if the moving distance of the selection reference point 1040 is d2 and the moving distance of the middle point 1015 of the segment 1018 is d1, d2=d1×c2. Here, a constant c2 can be set as a number (e.g., 1) which is relatively small, compared with a constant c when moving in a direction that is perpendicular to the segment 1018. The movement in the segment direction 1018 is right and left direction by user because the movement of the selection area 1030 in these directions can be solved by a rotation input which will be explained with reference to FIGS. 12a to 12d and 13.

FIGS. 12a to 12d illustrate a process for changing the direction of movement of a selection area according to an exemplary embodiment of the present invention.

FIG. 12a illustrates a display of a selection area according to another exemplary embodiment of the present invention.

FIG. 12b illustrates both before and after sensing a drag input (1201), FIG. 12c illustrates before sensing a drag input (1202), and FIG. 12d illustrates after sensing a drag input (1203).

FIG. 13 is a flowchart illustrating a process for moving a selection area according to an exemplary embodiment of the present invention.

FIG. 12a is very similar to FIG. 10a, but uses different reference numerals for the convenience of discussion.

Referring to FIG. 12a, the first touch point 1212 is a point that a touch is lastly inputted in the first area 1210, and the first area 1210 is a type of a circle with the first touch point 1212 as the center.

The second touch point 1222 is a point that a touch is lastly inputted in the second area 1220, and the second area 1220 is a type of a circle with the second touch point 1222 as the center.

The selection area 1230 is a type of a circle with the selection reference point 1240 as the center.

The segment 1218 is a segment which connects the first touch point 1212 with the second touch point 1222, and the straight line 1250 is a straight line which passes the middle point 1215 of the segment 1218 and is perpendicular to the segment 1218.

The selection reference point 1240 moves on the straight line 1250.

Referring to FIGS. 12b and 12c, before step 1310, the first touch point 1212 is the location of a first position 1212a, and the first area 1210 is displayed as a circle 1210a with the first position 1212a as the center. The second touch point 1222 is the location of a second position 1222a, and the second area 1220 is displayed as a circle 1220a with the second position 1222a as the center.

The selection reference point 1240 exists in a fifth position 1240a, and the selection area 1230 is displayed as a circle 1230a with the fifth position 1240a as the center.

The segment 1218 is positioned in the position of reference numeral 1218a, and the straight line which passes the middle point 1215 of the segment 1218 and is perpendicular to the segment 1218 is positioned in the position of reference numeral 1250a.

The middle point 1215 of the segment 1218 and the selection reference point 1240 are positioned away from each other by a distance k. Each area before step 1310 is displayed by dotted lines.

A touch interface senses a drag input of the first area 1210 and the second area 1220 (1310).

The drag input of the first area 1210 is started from the first position 1210a and is continued to a third position 1210b, and the drag input of the second area 1210 is started from the second position 1220a and is continued to a fourth position 1220b. Actually, user can input such a drag in such a manner that user rotates his wrist in the state where two fingers contact the area of reference numeral 1210a and the area of reference numeral 1220a.

Since the method for sensing a drag input was explained with reference to FIGS. 10a to 10d and 11, detailed explanation is omitted here.

A touch interface moves the display of the first area 1210 to the position of reference numeral 1210b, and moves the display of the second area 1220 to the position of reference numeral 1220b (1320).

Since the change of the displayed position of the first area and the second area according to a drag input was explained with reference to FIGS. 10a to 10d and 11, detailed description is omitted here.

The touch interface moves the display of the selection area 1230 to the position of reference numeral 1230b (1330).

The segment which connects the first touch point 1212 with the second touch point 1222 according to a drag input at step 1310 is rotated from the position of reference numeral 1218a to the position of reference numeral 1218b with the center of the segment 1218 as the axis.

If the segment 1218 is rotated, the straight line 1250 is rotated with the segment 1218 to maintain the angle (here, 90°) with the segment 1218. That is, the straight line 1250 moves from the position of reference numeral 1250a to the position of reference numeral 1250b. Accordingly, the position of the selection reference point 1240 also moves from the fifth position 1240a to a sixth position 1240b.

When a rotation drag is inputted as shown in FIGS. 12a to 12d, the distance between the middle point 1215 of the segment 1218 and the selection reference point 1240 can be set to be maintained constantly.

According to another exemplary embodiment of the present invention, the distance between the middle point 1215 of the segment 1218 and the selection reference point 1240 can be changed according to a rotation drag input. Hereinafter, it is assumed that the distance between the middle point of the segment 1218 and the selection reference point 1240 is maintained constantly.

Since the position of the selection reference point 1240 moves from the fifth position 1240a to the sixth position 1240b, the selection area 1230a also moves to the position of a circle 1230b with the sixth position 1240 as the center.

If the distance between the middle point 1215 of the segment 1218 and the selection reference point 1240 is relatively long, and the length of the segment 1218 is short, the rotation of the segment 1218 is possible by a small hand movement, but the selection area moves a long distance so that user can conveniently perform one of select, operate and move an item of a long distance.

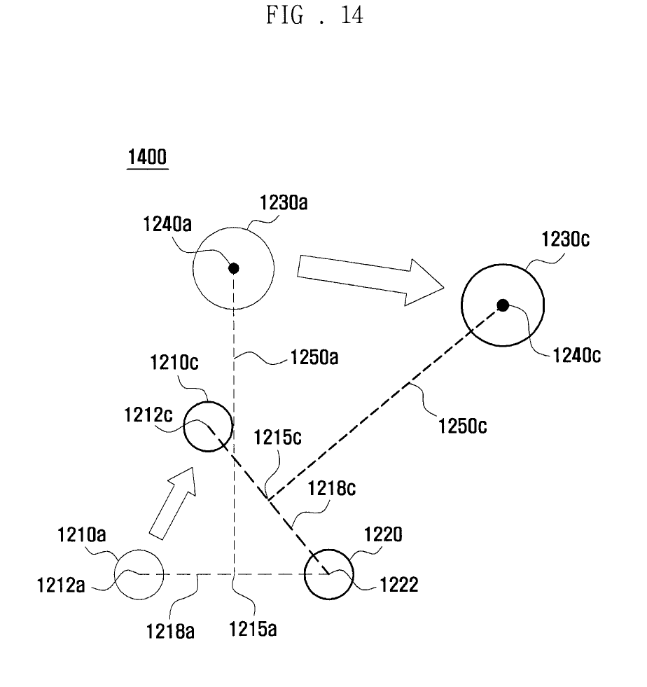

FIG. 14 illustrates a method for moving a selection area according to another exemplary embodiment of the present invention.

The embodiment of FIG. 14 is similar to that of FIGS. 12a to 12d, but it is a case where there is no drag input in the second area 1220, and a drag input is sensed only in the first area 1210. That is, it is a case where user drags by touching only the first area 1210 with a finger.

The drag input in the first area 1210 is started from the first position 1210a and is continued to a seventh position 1210c. Hence, the first touch point 1212 moves from the first position 1212a to a seventh position 1212c, and the segment 1218 moves from the position of reference numeral 1218a to the position of reference numeral 1218c. The middle point 1215 of the segment 1218 moves from the position of 1215a to the position of reference numeral 1215c, and accordingly, the straight line which is perpendicular to the segment 1218 also moves from the position of reference numeral 1250a to the position of reference numeral 1250c in order to maintain the angle (here, 90°) with the segment 1218. The selection reference point 1240 is positioned on the straight line 1250, and moves from the fifth position 1240a to an eighth position 1240c so that the distance with the middle point 1215 of the segment 1218 is maintained constantly. The selection area 1230 moves from the circle 1230a with the fifth position 1240a as the center to the circle 1230c with the eighth position 1240c as the center.

According to an exemplary embodiment of the present invention, as illustrated in FIG. 14, in case a drag input is sensed in the first area 1210, if a touch input is not sensed in the second area 1220, the distance between the selection reference point 1240 and the middle point 1215 of the segment 1218 can be set to be maintained constantly. On the other hand, in case a touch input is sensed in the second area 1220, the selection area 1230 can be moved in a direction that is perpendicular to the segment 1218 according to the moving distance in a direction that is perpendicular to the segment 1218 of the middle point 1215 of the segment like the embodiment of FIGS. 10a to 10d.

According to the embodiment of FIG. 14, it is advantageous in that user does not need to excessively bend the wrist even in case many rotations are required unlike the embodiment of FIGS. 12a to 12d.

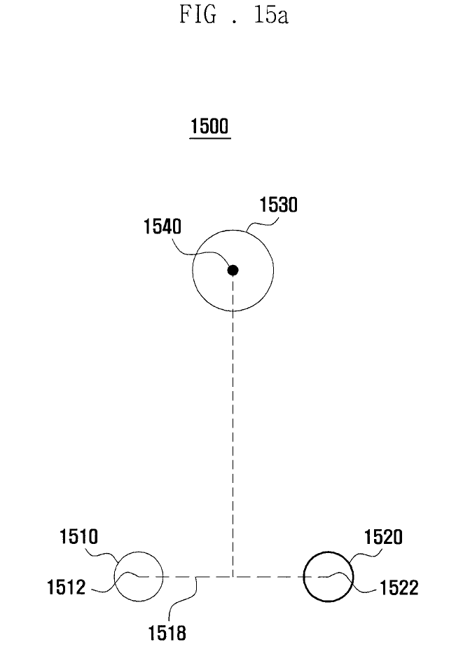

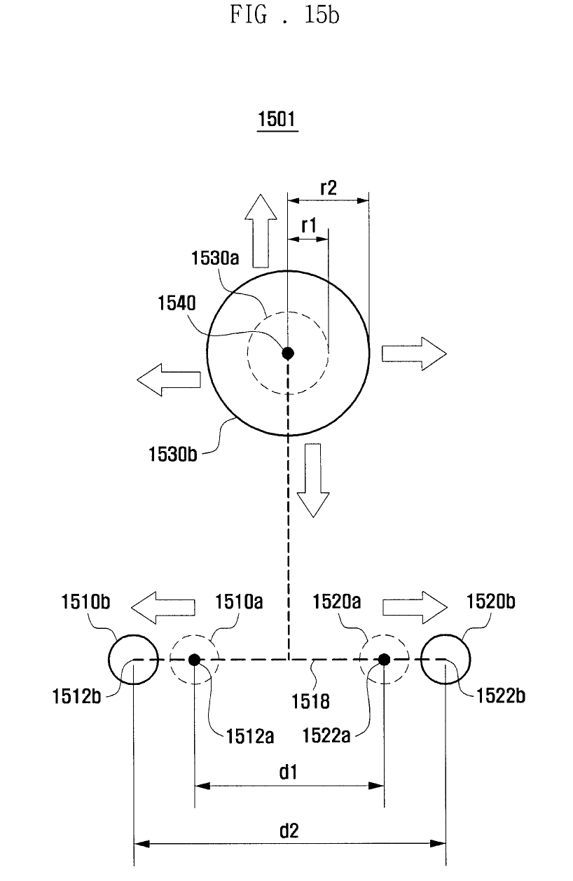

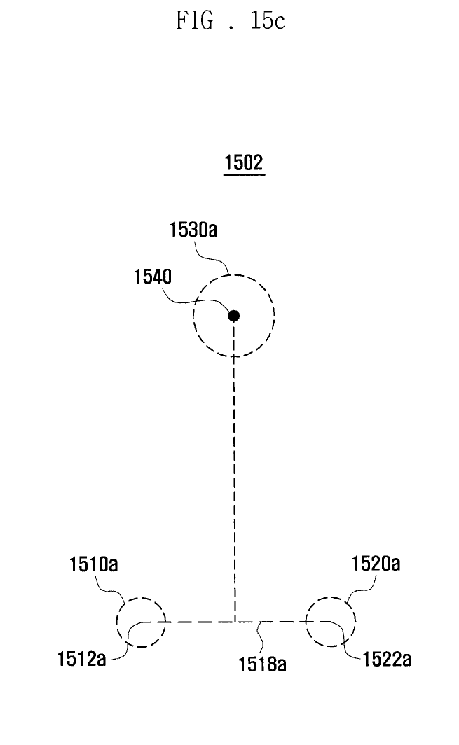

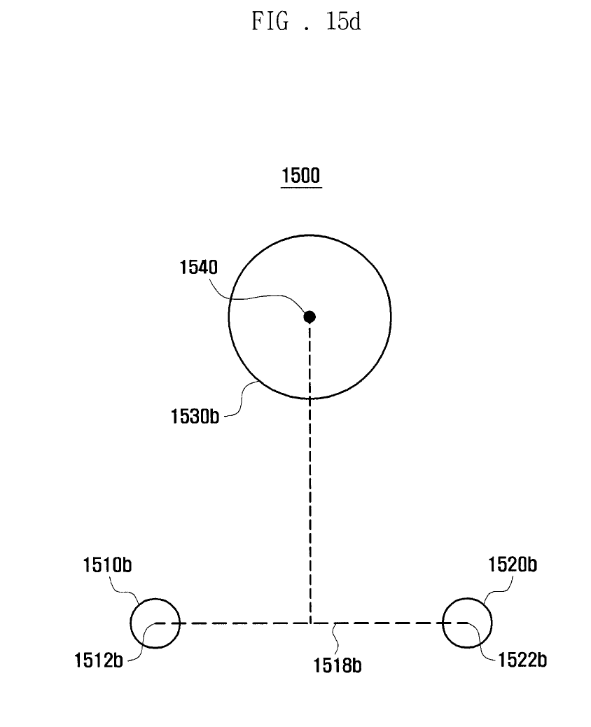

FIGS. 15a to 15d illustrate a process for changing the size of a selection area according to an exemplary embodiment of the present invention.

FIG. 15a illustrates a screen 1550 for displaying a selection area according to an exemplary embodiment of the present invention.

FIG. 15b illustrates a screen 1501 for displaying a selection area before and after a drag input at step 1610.

FIG. 15c illustrates a screen 1502 for displaying a selection area before a drag input at step 1610.

FIG. 15d illustrates a screen 1503 for displaying a selection area after a drag input at step 1610.

Referring to FIG. 15a, a first touch point 1512 is a point that is lastly touched in a first area 1510, and a second touch point 1522 is a point that is lastly touched in a second area 1520.

The first area 1510 is displayed as a circle 1510 with the first touch point 1512 as the center, and the second area 1520 is displayed as a circle 1520 with the second touch point 1522 as the center. A segment 1518 is a segment which connects the first touch point 1512 with the second touch point 1522.

The selection area 1530 is displayed as a circle 1539 with the selection reference point 1540 as the center.

Referring to FIGS. 15b and 15c, before step 1620, the first touch point 1512 is positioned in the first position 1512a, and the first area 1510 is displayed as a circle 1510a with first position 1512a as the center. The second touch point 1522 is positioned in the second position 1522a, and the second area 1520 is displayed as a circle 1520a with the second position 1522a as the center. The length of a segment 1518 which connects the first position 1510 with the second position 1520 is d1. In addition, the selection area 1530 is displayed as a circle 1530a with the selection reference point 1540 as the center where the length of the radius of the circle is r1. Each area before step 1610 is displayed by dotted lines.

A touch interface senses a drag input in the first area 1510 and the second area 1520 (1610). The drag input of the first area 1510 is started from the first position 1512a and is continued to a third position 1512b, and the drag input in the second area 1520 is started from the second position 1522a and is continued to a fourth position 1522b. In the state fingers contact the first area 1510 and the second area 1520, if actual user makes an input of widening the space between the fingers, the touch interface can sense such a drag input.

Referring to FIGS. 15b and 15d, the touch interface moves the display of the first area 1510 and the second area 1520 according to a drag input (1620). Since the drag input in the first area 1510 is started from the first position 1512a and is continued to the third position 1512b, the first area 1510 is moved to the position of a circle with the third position 1512b as the center.

Since the drag input in the second area 1520 is started from the second position 1522a and is continued to the fourth position 1522b, the second area 1520 is moved to the position of a circle 1520b with the fourth position 1522b as the center.

The distance (i.e., the length of the segment 1518) between the first touch point 1512 and the second touch point 1522 is d1 (1518a) before a drag input and d2 (1518b) after a drag input.

The touch interface changes the size of the selection area 1530 to have one of a positive and negative correlation with the length of the segment 1518 (1630).

In the embodiment of FIGS. 15a to 15d, the size of the selection area 1530 is changed to have a positive correlation with the length of the segment 1518.

For example, the length of the segment 1518 is increased from d1 to d2, so that the radius of the selection area 1530 can also be increased from r1 to r2, thereby increasing the size of the selection area 1530.

According to an exemplary embodiment of the present invention, the length d of the segment 1518 and the radius r of the selection area 1530 can be directly proportional to each other. That is, the length r of the radius of the selection area 1530 can be changed to maintain the relation of r=d×c (c is a constant larger than 0).

Here, if c is ½, the length of the diameter of the selection area 1530 and the length of the segment 1518 are maintained to be the same.

According to another exemplary embodiment of the present invention, the length d of the segment 1518 and the length r of the radius of the selection area 1530 can be one of inversely proportional to each other, and can form other functional relationship.

For example, the length r of the radius can be maintained so that the relation of r(d)=i*d^{1/2}+j (i and j are a constant larger than 0) can be maintained. Here, it was assumed that the selection area 1530 is a circle, but the idea of the present invention can be applied to cases where the selection area 1530 is any of a quadrangle and a triangle and any other shape.

In the embodiment of FIGS. 15a to 15d, only the case where the length of the segment 1518 is increased is illustrated, but the same method can be used for the case where the length of the segment 1518 is decreased.

In the embodiment of FIGS. 15a to 15d, it is assumed that a drag input is sensed in both the first area 1510 and the second area 1520, but even in case the drag input is sensed only in one of the first area 1510 and the second area 1520, the size of the selection area 1530 can be changed and displayed according to the change in the length of the segment 1518.

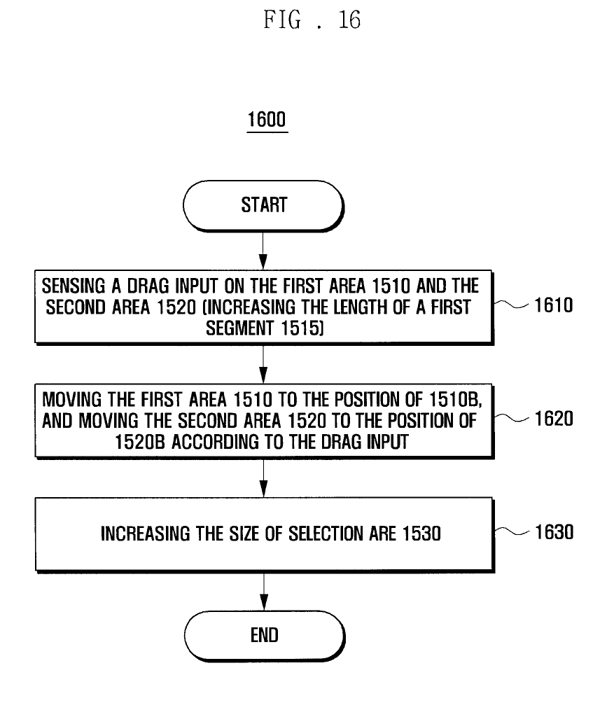

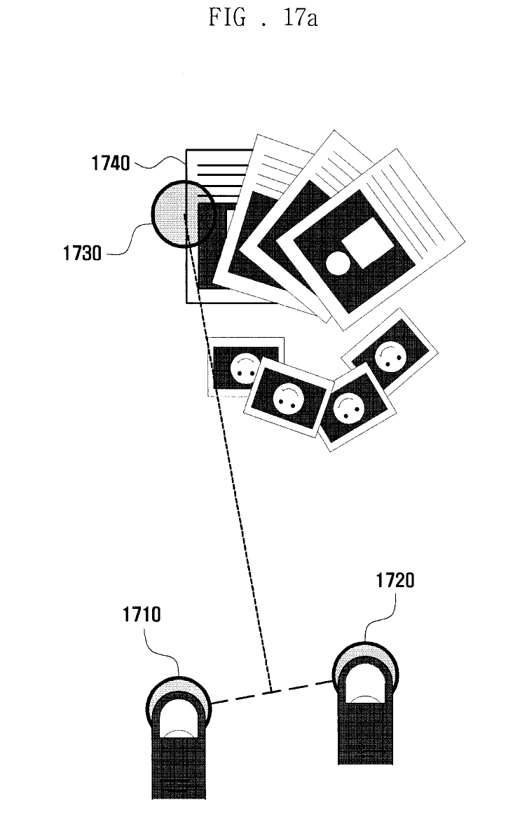

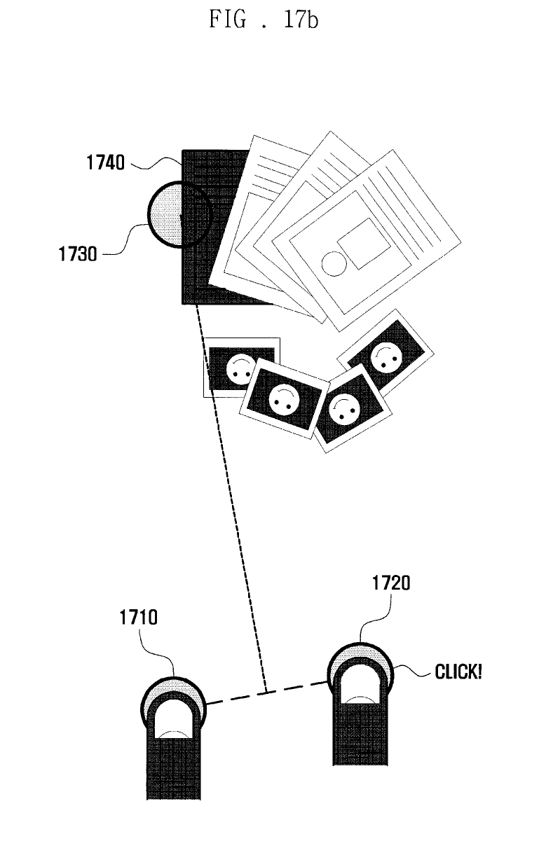

Each exemplary embodiment of FIGS. 10a to 16 can be independently implemented, but the embodiments can also be implemented as their combination.

For example, if the length of the segment 1518 is increased and, at the same time, rotated according to the drag input of the first area 1510 and the second area 1520, the size of the selection area 1530 can be increased, and at the same time, the position of the selection area 1530 can be moved according to the rotation of the segment 1518.

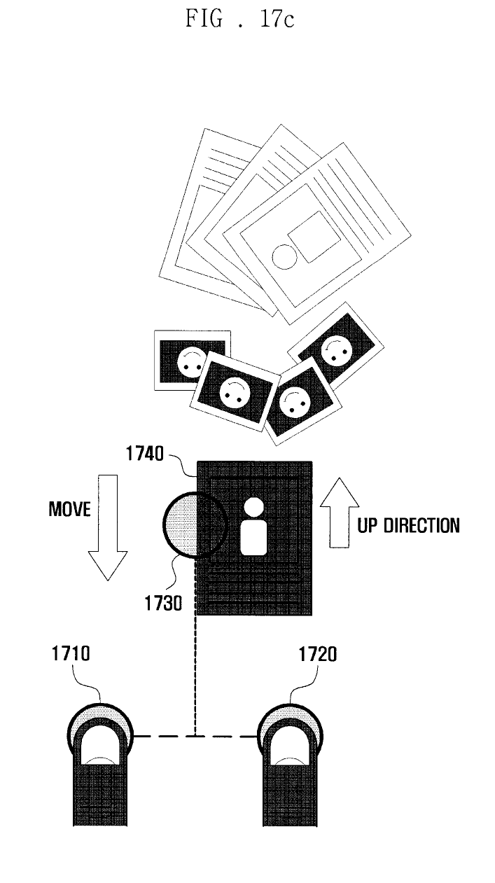

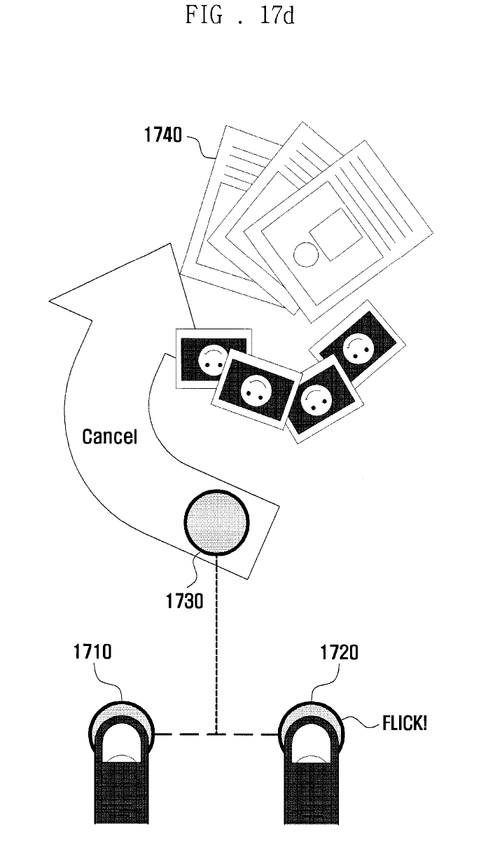

FIGS. 17a and 17b illustrate a process for selecting contents according to an exemplary embodiment of the present invention.

In FIG. 17a, user can move a selection area 1730 to contact a first item 1740 in the same method used in FIGS. 10a to 16. According to another exemplary embodiment of the present invention, user can make a selection area 1730 contact the first item by one of directly dragging and dropping the selection area 1730 to move it and directly dragging and dropping the first item 1740 to move it.

If the selection area 1730 contacts the first item 1740, the first item 1740 can be modified and displayed. That is, in order to indicate that the selection area 1730 contacted the first item 1740 and thus the selection is possible one of a shadow can be added to the display of the first item, a color of the first item can be inverted, and a rim of the first item can be displayed thicker such that the first item can be distinguished from other items.

In case the selection area 1730 contacts several items one of the item which has the largest contact portion among the contacted items can be differently displayed, all the contacted items can be differently displayed, and the item which contacted the center of the selection area 1730 can be differently displayed. In this case, only the differently displayed item becomes the object of the selection.

Referring to FIG. 17b, after the state of FIG. 17a, if one of a touch input is started in the second area 1720 in the state where the touch input is continued in the first area 1710, and a touch input is started in the first area 1710 in the state where the touch input is continued in the second area 1720, the first item 1740 becomes the selected state.

The start of the touch input in the second area 1710 can include several inputs including any of a click and a double click. Only a click input according to the setting of one of user and a software provider may be recognized as a selection input.

In order to display the state where the first item 1740 is selected, the touch interface can one of add shadow to the display of the first item 1740, invert the color, and make the rim thicker. However, the display of contact between the selection area 1730 and the first item 1740 in FIG. 17a and the display of the selection of the first item 1740 in FIG. 17b must be displayed in different ways so that they might be distinguished by user.

In FIG. 17a, the rim is displayed thicker in the state where the selection area 1730 contacts the first item 1740. In FIG. 17b, the rim is displayed thicker and, at the same time, the shadow is displayed as the state where the first item 1740 is selected by a click of the second area 1720. According to another exemplary embodiment of the present invention, the click for only one of the second area 1720 and the first area 1710 according to one of a setting of user and a software provider can be recognized as a selection command of the first item 1740. For example, if only the click for the second area 1720 is set to be recognized as a selection command by user, the click for the first area 1720 is not recognized as a selection command.

The first area 1710 and the second area 1720 can be distinguished by the order of a first touch time point (a time point when the selection area 1730 is generated).

For example, if the selection area 1730 is generated by touching an area of reference numeral 1720 in a state where user is already touching an area of reference numeral 1710, the area of reference numeral 1710 becomes a first area and the area of reference numeral 1720 becomes a second area, but if the order of the touch is reversed, the first area and the second area are exchanged.

According to another exemplary embodiment of the present invention, assuming that the position of the selection area 1730 is the front, a left area can be the first area and a right area can be the second area. In case of FIGS. 17a and 17b, assuming that the selection area 1730 is a front side, the area of reference numeral 1710 is the left area, so that it becomes the first area, while the area of reference numeral 1720 is the right area, so that it becomes the second area.

According to another exemplary embodiment of the present invention, any of a double click, a flip and a flick can be recognized as a selection command for an item instead of user click on one of the first area 1710 and the second area 1720.

As illustrated in FIG. 17b, a specific input is received in a state where the first item 1740 is selected, the selection of the first item is cancelled, and the touch interface can change the first item 1740 to a state like FIG. 17a. For example, in the state where a touch input is continued in the first area 1710, if a click input on the second area 1720 is sensed, the first item 1740 is displayed as the selected state, and in the state where the touch input on the second area 172 is continued, if a click input on the first area 1710 is sensed, the first item 1740 is not selected, and can be displayed as a selectable state (FIG. 17a). The selection cancellation input can be a different input according to the setting of one of a user and a software provider.

FIG. 17c illustrates a method for moving a first item 1740.

As illustrated in FIG. 17b, if a selection area 1730 is moved in the same method used in FIGS. 10a to 16 in a state where a first item 1740 is selected, the selection area 1730 and the first item 1740 can be associated to move and display them simultaneously. Here, particularly, in case of an item which has the upper side and the lower side that can be distinguished from each other, as shown in FIG. 17c, the upper direction can be rotated to be the direction opposite to the moving direction of the first item 1740 and the selection area 1730. In this case, user can clearly see the display of the moving first item 1740.

FIG. 17d illustrates a process for moving an item according to an exemplary embodiment of the present invention.

As shown in FIG. 17c, if a flick input on the second area 1720 is sensed while an item is selected and moved, the touch interface moves the first item 1740 back to the initial position where movement was started. That is, the movement is cancelled. While moving an item, if user wants to cancel the movement of the time, he can input a flick on the second area. The flick input refers to an input that flips or taps softly using the end of a finger. The click input and the flick input can be distinguished based on any of duration of a touch, intensity of a touch and the area of a touch.

According to another exemplary embodiment of the present invention, in case there is another input for another area according to user setting, for example, there is a double click input for the first area 1710, the touch interface can cancel the movement. A flick input one of may be and may not be recognized as a movement cancellation command according to the position where the flick input was sensed among the first area 1710 and the second area 1720, and if the flick input is sensed regardless of the distinction of the first area 1710 and the second area 1720, it can be recognized as a movement cancellation command. In case a flick input is sensed in the selection area 1730, the flick input can be recognized as a movement cancellation command.

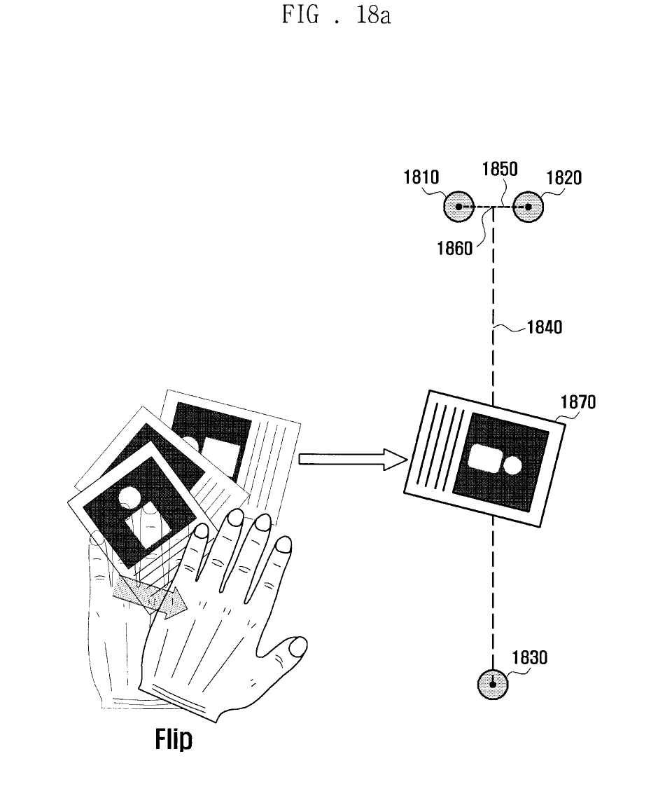

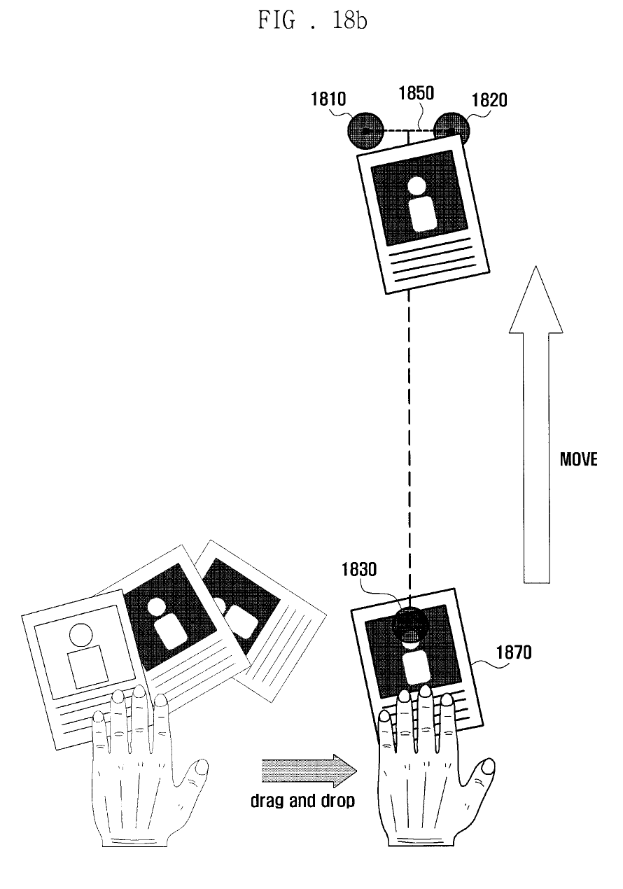

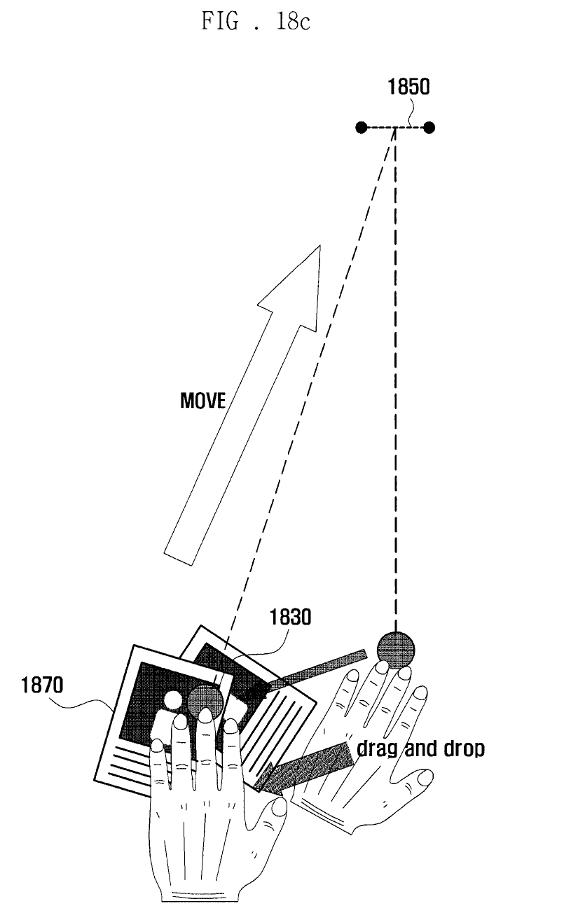

FIG. 18a illustrates a process for moving an item according to an exemplary embodiment of the present invention

A selection area 1830 is displayed according to the touch input of a first area 1810 and a second area 1820. At this time, it is assumed that a segment which connects a middle point 1860 of a first segment 1850 which connects the first area 1810 with the second area 1820, with the selection area 1830, is a second segment 1840 or DR PATH 1840. If user inputs a flip on an item 1870, the item 1870 moves according to the direction and speed of the flip input. If the item one of contacts the DR PATH 1840 during the movement and approaches the DR PATH 1850 within a certain distance, the movement is stopped in the state where the item is contacting the DR PATH 1840.

The flip input refers to an input which quickly snatches the item while contacting a finger as if one turns a page. The flip is distinguished from a drag and drop according to the difference in a moving speed of one of a touch input portion and the intensity of the touch input. Thereafter, if the selection area 1830 moves according to a drag input for the first area 1810 and the second area 1820, the item 1870 is moved in a state where it contacts the DR PATH 1840 according to a length change, a movement and a rotation of the DR PATH 1840. The movement can be done to constantly maintain the ratio of the distance between the middle point 1860 of the first segment 1850 and the item 1870 to the distance between the selection area 1830 and the item 1870.

According to another exemplary embodiment of the present invention, if the item 1870 one of contacts the DR PATH 1840 and approaches the DR PATH 1850 within a certain distance while moving, the item is moved to contact the selection area 1830, and the item becomes a selected state, so that the item can be associated with selection area 1830 and moved like the embodiment of FIGS. 17a to 17d.

According to another exemplary embodiment of the present invention, if the item 1870 one of contacts the DR PATH 1840 and approaches the DR PATH 1850 within a certain distance while moving, the item can be one of moved to contact the first segment 1850 and moved to approach the first segment 1850 within a certain distance. In this case, the item which contacts the DR PATH 1840 according to the flip input can be directly moved to a place near user who gave a touch input on the first area 1810 and the second area 1820.

FIGS. 18b and 18c illustrate a process for selecting and moving an item according to an exemplary embodiment of the present invention.

In FIG. 18b, the user drags and drops the item 1870 to make it to contact the selection area 1830, or moves the item 1870 from the selection area 1830 to a position within a second limitation distance (e.g., 3 cm) according to one of a setting of user and a touch interface provider.

Accordingly, the touch interface one of moves the item 1870 to be positioned within a first limitation distance (e.g., 3 cm) according to the setting of one of a user and a touch interface provider from the first segment 1850, and moves the item 1870 to be contacted with the first segment 1850.

According to another embodiment, the user one of drags and drops the item 1870 to make it contact the selection area 1830, and moves the item 1870 from the selection area 1830 to a position within the second limitation distance (e.g., 3 cm) according to the setting of one of the user and the touch interface provider. Thus, the touch interface displays the item 1870 in the selected state, and then, the item 1870 moves in association with the selection area 1830 when the selection area 1830 moves.

In FIG. 18c, the user one of drags and drops the selection area 1830 to make it to contact the item 1870, and moves the item 1870 from the selection area 1830 to a position within the second limitation distance (e.g., 3 cm) according to the setting of one of the user and the touch interface provider. Accordingly, the touch interface one of moves the item 1870 to be positioned within a first limitation distance (e.g., 3 cm) according to the setting of one of the user and the touch interface provider from the first segment 1850, and moves the item 1870 to be contacted with the first segment 1850.

According to another embodiment, the user one of drags and drops the selection area 1830 to make it to contact the item 1870, and moves the selection area 1830 from the item 1870 to a position within the second limitation distance (e.g., 3 cm) according to the setting of one of the user and the touch interface provider. Thus, the touch interface displays the item 1870 in the selected state, and then, the item 1870 moves in association with the selection area 1830 when the selection area 1830 moves.

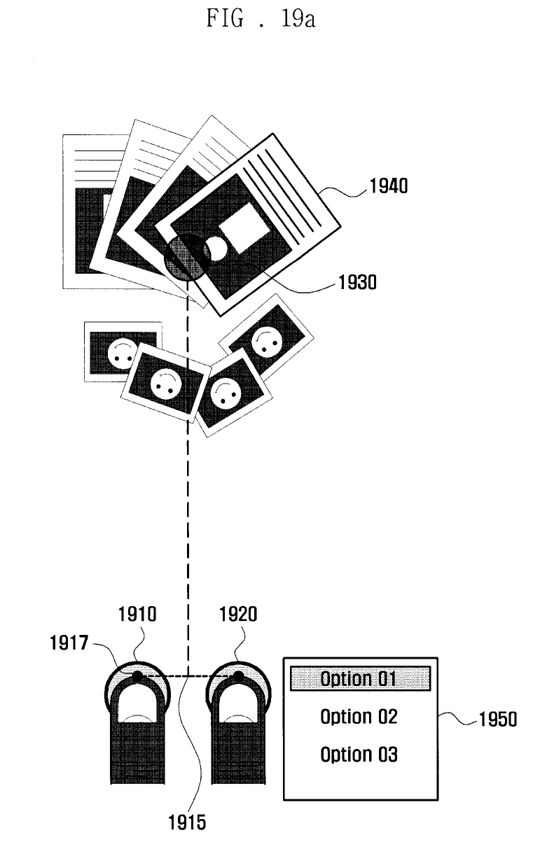

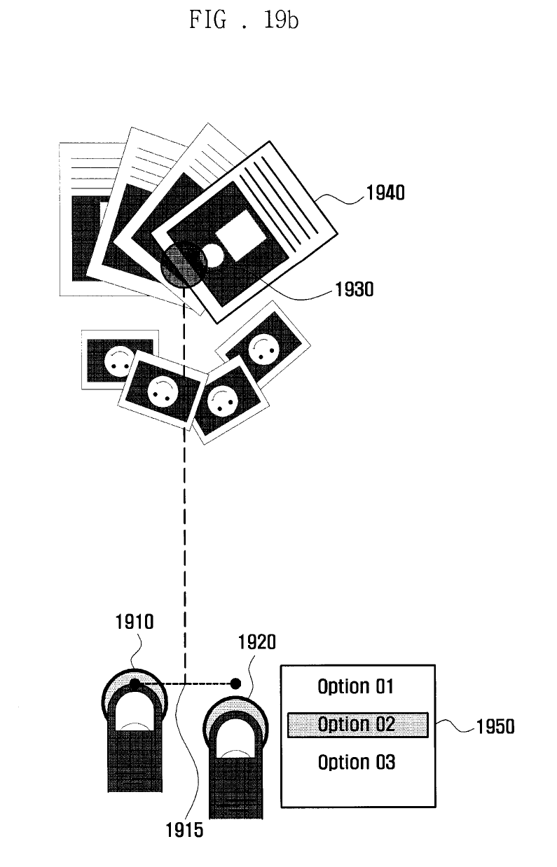

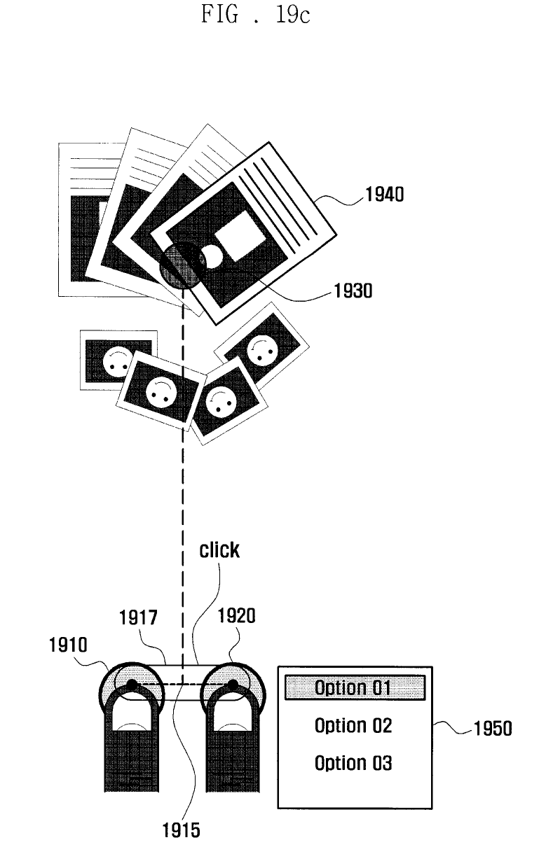

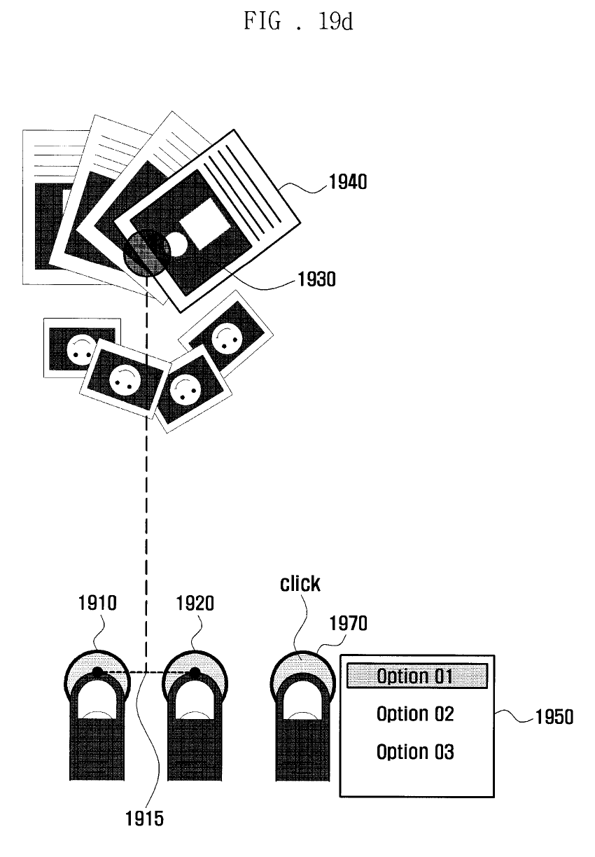

FIGS. 19a to 19d illustrate a process for displaying an option window 1950 according to an exemplary embodiment of the present invention

Referring to FIG. 19a, if a touch input on a second area 1920 starts (e.g., click input) while touch input on a first area 1910 is continued in a state where the item 1940 is in a selected state, as illustrated in FIG. 17b, the touch interface can display an option window 1950. According to another embodiment, the option window 1950 can be displayed even when touch input on the first area 1910 starts while touch input on the second area 1920 is continued.

Referring to FIG. 19b, if the touch interface senses a drag input on the second area 1920 in the state where the option window 1950 is displayed, the selection display of the option window 1950 can be changed instead of one of moving the selection area 1930 and changing a size of the selection area 1930. In other words, selection display such as Option 01 and Option 02 can be changed. In this state, if a click input on the second area 1920 is sensed, the option can be one of performed and applied. In FIG. 19b, when the second area 1920 is clicked, the option 02 is one of performed and applied.

According to an embodiment of FIG. 19c, when the touch interface senses a click input in a third area 1917 that includes a first segment 1915 which connects the first area 1910 with the second area 1920, the option window 1950 can be displayed. One of a detailed shape and an area of the third area may be changed according to the setting of one of a user, a software provider and an interface manufacturer.

According to an embodiment of FIG. 19d, if a click input on an arbitrary fourth area 1970 which does not belong to the first area 1910 and the second area 1920 is sensed, the option window 1950 can be displayed while touch input is continued in both of the first area 1910 and the second area 1920. The fourth area 1970 can include one of all and part of an area which does not belong to the first area 1910 and the second area 1920 according to the setting of one of the user, the software provider and the interface manufacturer.

Hereinafter, a method for providing interface of an umbrella type is described.

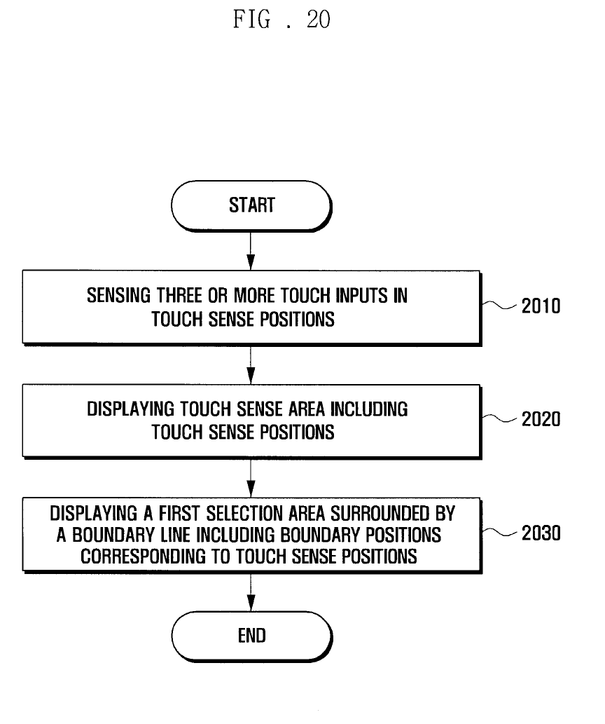

FIG. 20 illustrates a flowchart of a method for displaying a selection area and a touch sensing area according to an exemplary embodiment of the present invention

A touch interface senses a touch input at least three touch sense positions (2010). The at least three touch inputs must be simultaneously sensed, and must be sensed at different positions. However, in an alternative embodiment, the first selection area can be displayed when at least three touch inputs are sensed within a preset time (e.g., 3 seconds).

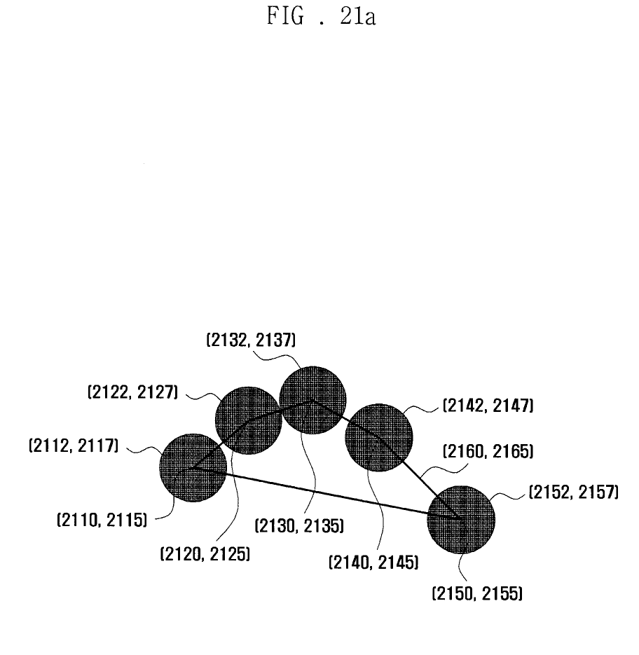

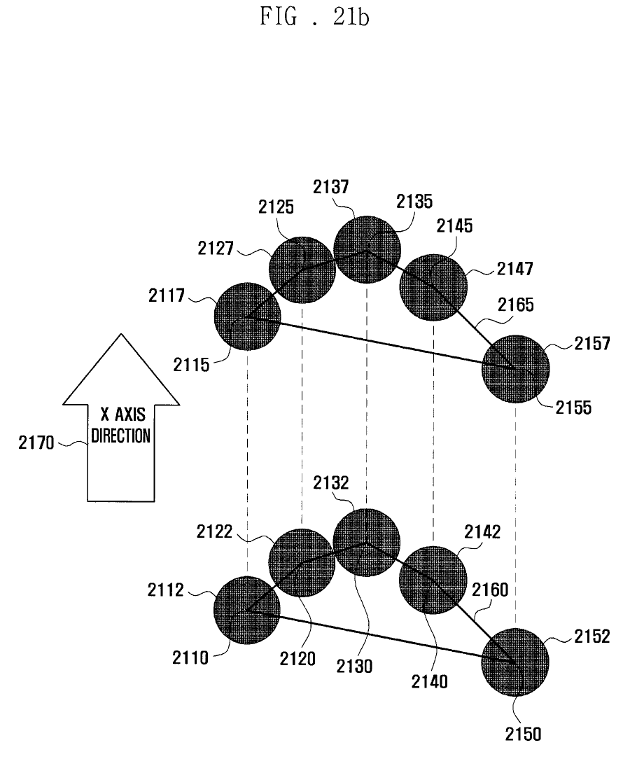

FIG. 21a illustrates a touch interface screen according to an exemplary embodiment of the present invention

Referring to FIG. 21a, the touch interface simultaneously senses a touch input at a first touch sense position 2110, a second touch sense position 2120, a third touch sense position 2130, a fourth touch sense position 2140, and a fifth touch sense position 2150 (2010). Since at least three touch inputs are simultaneously sensed, the umbrella interface may be provided. The touch interface displays a touch sense area including each touch sense position (2020).

A first touch sense area 2112 is a circle which has a center that exists in the first touch sense position 2110, a second touch sense area 2122 is a circle which has a center that exists in the second touch sense position 2120, a third touch sense area 2132 is a circle which has a center that exists in the third touch sense position 2130, a fourth touch sense area 2142 is a circle which has a center that exists in the fourth touch sense position 2140, and the fifth touch sense area 2152 is a circle which has a center that exists in the fifth touch sense position 2150. The touch interface displays a first selection area surrounded by a boundary line 2165 including boundary positions 2115, 2125, 2135, 2145, 2155 corresponding to respective touch sense positions 2110, 2120, 2130, 2140, 2150 (2030).

In an embodiment of FIG. 21a, the touch sense positions 2110, 2120, 2140 and 2150 and corresponding positions 2115, 2125, 2135, 2145 and 2155 are not distinguished as they are positioned in the same positions respectively. The first selection area surrounded by boundary line 2165 is used as an area for selecting items afterward.

FIG. 21b illustrates a touch interface screen according to another exemplary embodiment of the present invention.

Referring to FIG. 21b, the touch interface simultaneously senses a touch input in a first touch sense position 2110, a second touch sense position 2120, a third touch sense position 2130, a fourth touch sense position 2140 and a fifth touch sense position 2150 (2010).

The touch interface displays the touch sense areas including respective touch sense positions (2020). The first touch sense area 2112 is a circle which has the center that exists in the first touch sense position 2110, the second touch sense area 2122 is a circle which has the center that exists in the second touch sense position 2120, the third touch sense area 2132 is a circle which has the center that exists in the third touch sense position 2130, the fourth touch sense area 2142 is a circle which has the center that exists in the fourth touch sense position 2140, and the fifth touch sense area 2152 is a circle which has the center that exists in the fifth touch sense position 2150. However, as explained referring to FIG. 7 and FIG. 3, the shape and size of each touch sense area depend on setting of user, program provider and touch interface manufacturer. The touch interface displays a first selection area 2165 surrounded by a boundary line including boundary positions 2115, 2125, 2135, 2145, 2155 corresponding to each touch sense positions 2110, 2120, 2130, 2140, 2150 (2030).

Differently from the example of FIG. 21a, in the example of FIG. 21b, each touch sense positions 2110, 2120, 2130, 2140, 2150 and each corresponding boundary positions 2115, 2125, 2135, 2145, and 2155 are not in the same position as each other. On the other hand, each boundary positions 2115, 2125, 2135, 2145, 2155 is separately positioned by a given distance in a certain direction from, respectively, each of the touch sense positions 2110, 2120, 2130, 2140, 2150. That is, the first boundary position 2115 is separately positioned by a given distance (e.g., 10 cm) in an x-axis direction 2170 from the first touch sense position 2110, the second boundary position 2125 is separately positioned by 10 cm in the x-axis direction 2170 from the second touch sense position 2120.

In addition, the third boundary position 2135 is separately positioned by 10 cm in the x-axis direction 2170 from the third touch sense position 2130, the fourth boundary position 2145 is separately positioned by 10 cm in the x-axis direction 2170 from the third touch sense position 2140, and the fifth boundary position 2155 is separately positioned by 10 cm in the x-axis direction 2170 from the fifth touch sense position 2150. Here, the x-axis direction 2170 may be the direction from the first side of the touch interface screen closest to the touch sense positions 2110, 2120, 2130, 2140, 2150 to the second side, which is the opposite side of the first side of the touch interface screen. The x-axis direction 2170 is defined such that the user who is at the first side is enabled to use the interface as shown in FIG. 21b for conveniently selecting the item near the second side.

According to an another embodiment, the x-axis direction 2170 may be a direction to which a user finger is directed, assuming that the touch sense positions 2110, 2120, 2130, 2140, 2150 are corresponding to the position of the finger. It is possible to analyze statistically the length information of the finger and determine the direction to which the finger is directed. The touch interface can further display boundary areas 2117, 2127, 2137, 2147, 2157 each of which has a shape of circle and each of which has a center that exists at respective boundary positions 2115, 2125, 2135, 2145, and 2155. In addition, the touch interface can further display the second selection area which is surrounded by the boundary line 2160 including touch sense positions 2110, 2120, 2130, 2140, 2150. The display of the first selection area surrounded by boundary line 2165 and the second selection area surrounded by boundary line 2160 may be polygonal as illustrated in FIG. 21b and may have a boundary line of a curved line type including boundary positions 2115, 2125, 2135, 2145, and 2155.

Furthermore, the boundary lines 2165 of the first selection area and the boundary lines 2160 of the second selection area need not necessarily include all of the touch sense positions 2110, 2120, 2130, 2140, 2150 or boundary positions 2115, 2125, 2135, 2145, and 2155. For example, the boundary lines 2165 of the first selection area and the boundary lines 2160 second selection area may form an oval which has the nearest average distance from one of the touch sense positions 2110, 2120, 2130, 2140, 2150 and the boundary positions 2115, 2125, 2135, 2145, 2155.

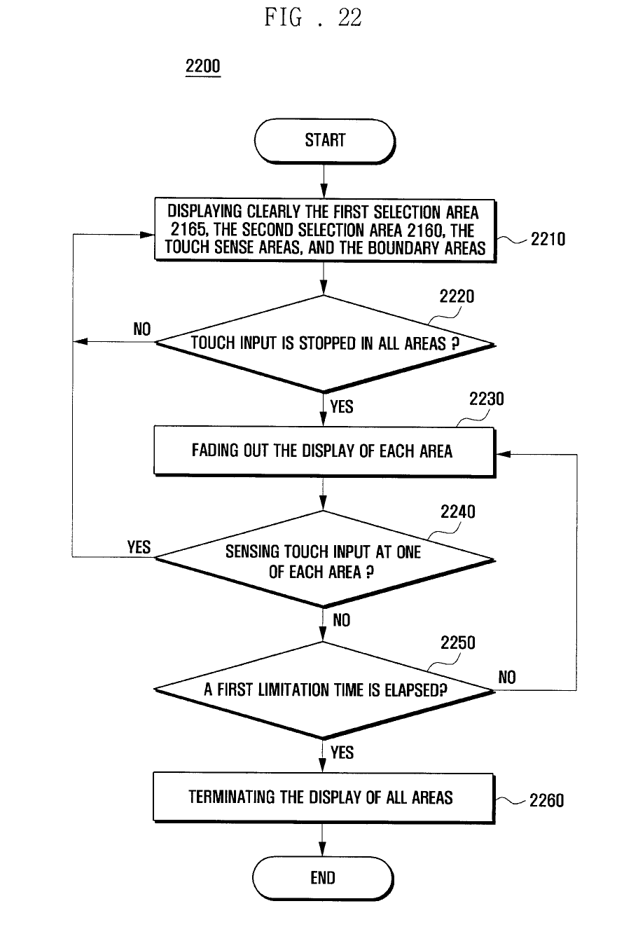

FIG. 22 is a flowchart 2200 illustrating a method for displaying a touch interface according to an exemplary embodiment of the present invention.

The touch interface which has received a touch input as illustrated in one of FIG. 21a and FIG. 21b displays clearly the first selection area 2165, the second selection area 2160, the touch sense areas 2112, 2122, 2132, 2142, 2152, and the boundary areas 2117, 2127, 2137, 2147, 2157 (2210).

It is determined whether the touch input is stopped in all areas (the first selection area surrounded by boundary lines 2165, the second selection area surrounded by boundary lines 2160, the touch sense areas 2112, 2122, 2132, 2142, 2152, and the boundary areas 2117, 2127, 2137, 2147, 2157) (2220).

If the touch input is not stopped, the process is returned to step 2210, and the clear display is continuously maintained. If the touch input is stopped, the display of each area (including the first selection area surrounded by boundary lines 2165, the second selection area surrounded by boundary lines 2160, the touch sense areas 2112, 2122, 2132, 2142, 2152, and the boundary areas 2117, 2127, 2137, 2147, and 2157) are faded out (2230).

Here, the detailed explanation regarding the fade out is omitted since it was already explained in the discussion above of FIG. 9.

The touch interface determines whether the touch input is sensed at least one of each area (including the first selection area 2165, the second selection area 2160, the touch sense areas 2112, 2122, 2132, 2142, 2152, and the boundary areas 2117, 2127, 2137, 2147, 2157) (2240).

If the touch input is sensed, the process is returned to step 2210 to maintain the clear display state. If the touch input is not sensed, it is determined whether a first limitation time (depended on setting of one of the user and the manufacturer) has elapsed while not sensing the touch input (2250).

If the first limitation time has elapsed, the display of all areas is terminated (2260). Thereafter, an interface as illustrated in FIG. 21a or FIG. 21b is provided only when at least three touch inputs are simultaneously sensed as illustrated in FIG. 21a or FIG. 21b. If the limitation time has not elapsed, the process returns to step 2230, and the display continues fading out. That is, the display is gradually faded out with lapse of time, and the display is completely cleared when the first limitation time has elapsed. The detailed explanation regarding the process for FIG. 22 is omitted since it is similar to the process for FIG. 9.

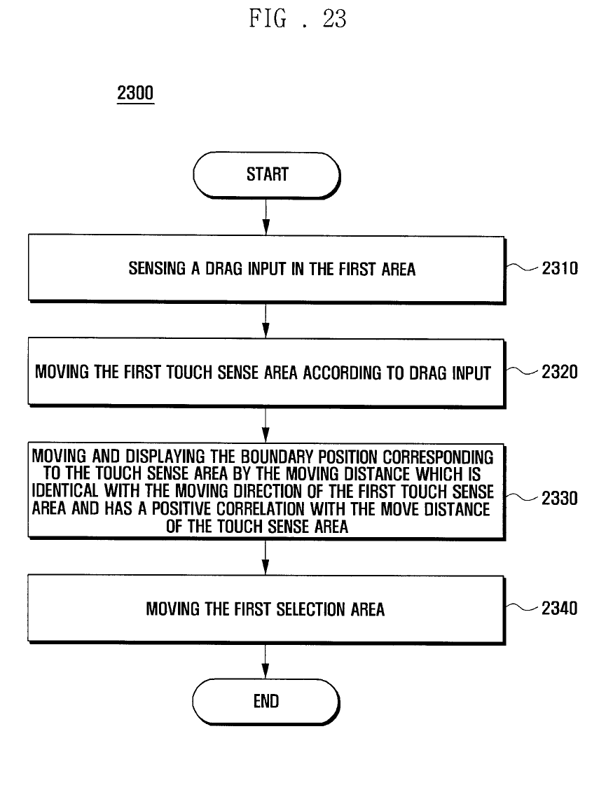

FIG. 23 is a flowchart illustrating a process for providing an interface according to an exemplary embodiment of the present invention.

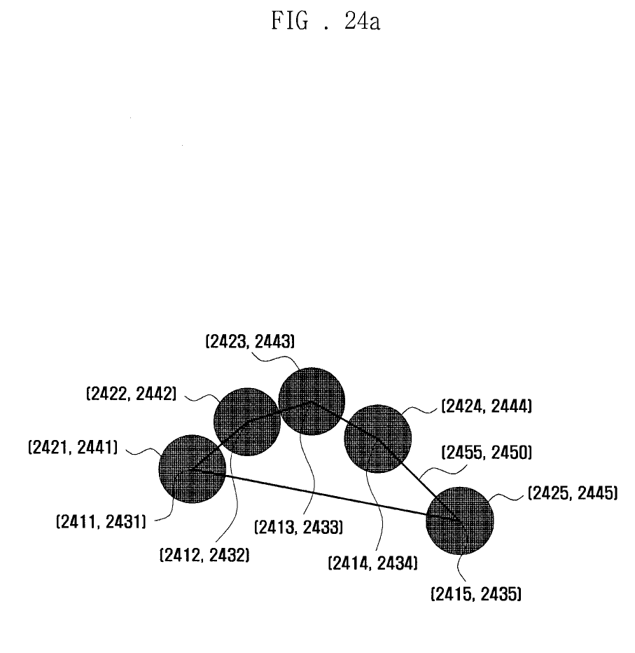

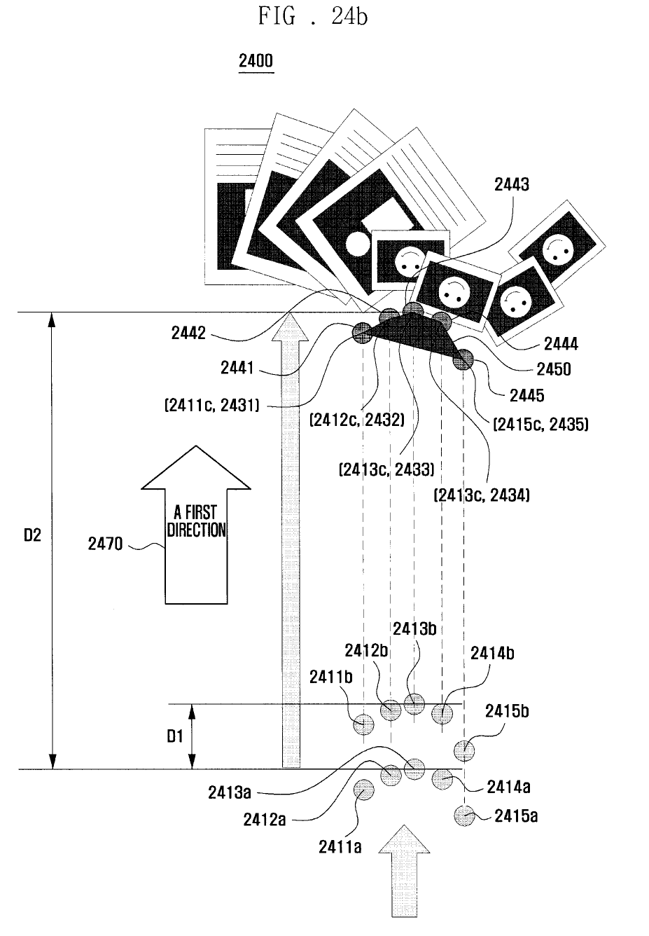

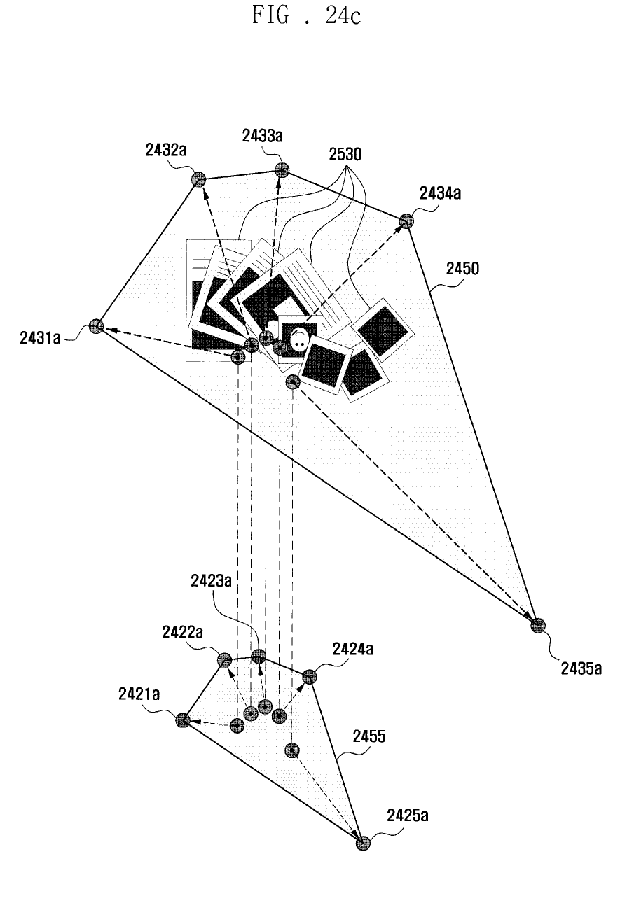

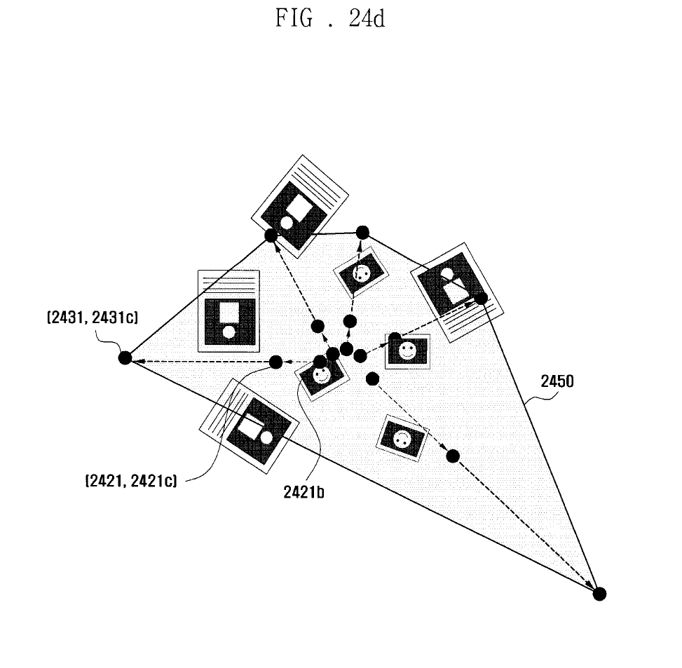

FIGS. 24a to 24d illustrates a process for moving a selection area according to an exemplary embodiment of the present invention.

Referring to FIG. 24a, a first touch sense position to a fifth touch sense positions 2411, 2412, 2413, 2414, 2415, and corresponding touch sense areas 2421, 2422, 2423, 2424, 2425 of a circle type centering each touch sense position are illustrated. a first boundary position to a fifth boundary position 2431, 2432, 2433, 2434, 2435, which are corresponding to the first touch sense position to the fifth touch sense position 2411, 2412, 2413, 2414, 2415, are positioned at the same position as the first touch sense position to the fifth touch sense position 2411, 2412, 2413, 2414, 2415. And the circular boundary areas 2441, 2442, 2443, 2444, 2445 centered on each boundary position have the same position, shape and size as the corresponding touch sense areas 2421, 2422, 2423, 2424, 2425. Before step 2310, a touch interface senses a touch input at a first position to a fifth position 2411a, 2412a, 2413a, 2414a, 2415a. Referring to FIG. 24b, the first touch sense position to the fifth touch sense position 2411, 2412, 2413, 2414, 2415 correspond to the first position to the fifth position 2411a, 2412a, 2413a, 2414a, 2415a. And as illustrated in the example of FIG. 21a, the circle type of the touch sense area 2421, 2422, 2423, 2424, 2425 centered on each touch sense position is displayed, and a first boundary position to a fifth boundary position which are corresponding to the first touch sense position to the fifth touch sense position 2411, 2412, 2413, 2414, 2415 are set to the same position as each touch sense position. That is, the first boundary position 2431 is the same position as the first touch sense position 2411, the second boundary position 2432 is the same position as the second touch sense position 2412, the third boundary position 2433 is the same position as the third touch sense position 2413, the fourth boundary position 2434 is the same position as the fourth touch sense position 2414, and the fifth boundary position 2435 is the same position as the fifth touch sense position 2415. And the circle type of boundary areas 2441, 2442, 2443, 2444, 2445 centered on each boundary position has the same position, shape and size as the corresponding touch sense areas 2421, 2422, 2423, 2424, 2425. A first selection area 2455 is a polygon having an apex at each boundary position, a second selection area 2450 is a polygon having an apex at each touch sense position, in early stage, the position of the first selection area 2455 is identical with the position of the second selection area 2456. The touch interface senses a drag input on the first touch sense area to the fifth touch sense area 2421, 2422, 2423, 2424, 2425 (2310).

The following explanation can be applied to all of the touch sense areas, but for convenience, here, only an explanation regarding to the first touch sense area 2421 is described. As shown in FIG. 24b, the drag input is inputted by the distance of D1 in a first direction 2470. The touch interface moves and displays the touch sense area 2421 in compliance with the drag input (2320). According to the drag input, the first touch sense position 2411 moves from the first position 2411a to a sixth position 2411b, and the touch interface displays the first touch sense area 2421 as a circle centered on the sixth position 2411b. As a result, the first touch sense area 2421 is moved by and displayed at distance of D1. The touch interface moves and displays the first boundary position 2431 corresponding to the first touch sense area 2421, by the moving direction which is identical with the moving direction of the touch sense area 2421 and has a moved distance with a positive correlation with the moved distance of the first touch sense area 2421 (2330).

Since the first touch sense area 2421 is moved by D1 in the first direction 2470, the first boundary position 2431 moves by D2 in the first direction 2470 to position at a seventh position 2411c, and the first boundary area 2441 is displayed with a circle centered on the seventh position 2411c. The lengths of D1 and D2 have a positive correlation. For example, a direct proportion relationship of D₂=D₁×C (C is a constant of 1 or more) may be established. According to another example, the relationship of D₂=D₁½×C may be established. Here, a detailed explanation with regard to the exemplary illustration of the positive correlation is omitted since it has already explained with reference to FIG. 10a to FIG. 10d. The touch interface one of modifies and moves and displays the first selection area 2450 in accordance with the moved first boundary position 2431 (2340).

In the example of FIG. 24b, since the first touch sense position to the fifth touch sense position 2411, 2412, 2413, 2414, 2415 move by D1 in the first direction, the first boundary position to the fifth boundary position 2431, 2432, 2433, 2434, 2435 move by D2, and are displayed, the first selection area also moves by D2 in the first direction, and then is displayed. There is no need that all of the drag inputs are necessarily made in the same direction as FIG. 24b. FIG. 24c shows a change of the first selection area 2450 in case of a drag input in which the user spreads out his finger widely.

In FIG. 24c, the touch interface receives a drag input of the first touch sense area 2421 which is positioned in the first circle 2421a.

A first boundary position 2431 corresponding to a first touch sense area 2421 moves to an eighth position 2431a and is displayed there. Here, the movement direction of the first touch sense area 2421 and the movement direction of a boundary position 2431 are same, the movement direction of the first touch sense area 2421 and the movement direction of the boundary position 2431 have a positive correlation. According to the movement of other touch sense areas, a corresponding boundary position also moves, and accordingly, the first selection area 2450 occupies a wide area as illustrated in FIG. 24c. If the movement distance of the boundary position is greater than the movement distance, even though user moves his finger only a little, the selection area is moved far away and the size of the selection area is easily widened.

FIG. 24d illustrates a method for providing an interface according to another exemplary embodiment of the present invention.

Differently from FIG. 24b or FIG. 24c, it may be possible to expand the selection area at the present place before sending the selection area to remote location. The first touch sense area 2421 exists at the position 2421b and then moves to a position of the reference numeral 2421c in accordance with a drag input by user. Accordingly, the first boundary position 2431 corresponding to the first touch sense area 2421 exists in the same position 2421b as the first touch sense position 2421 and then moves in the same direction as the movement direction of the first touch sense area 2421, thereby moving to the position 2431c. The movement distance of the first touch sense area 2421 and the distance of the first boundary position 2431 have a positive correlation with each other. The boundary position also moves with respect to the drag input of other touch sense areas, and the shape of the first selection area 2450 is changed. It is not necessary to continue the touch input for all touch sense areas. Even though the touch input is sensed only for a part of the touch sense areas, the change of the selection area like FIG. 23 to FIG. 24d is possible.

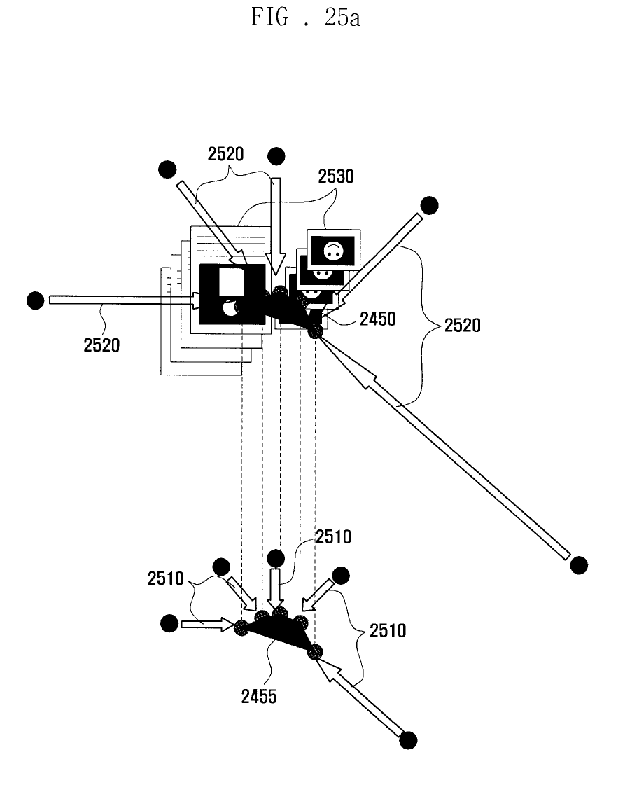

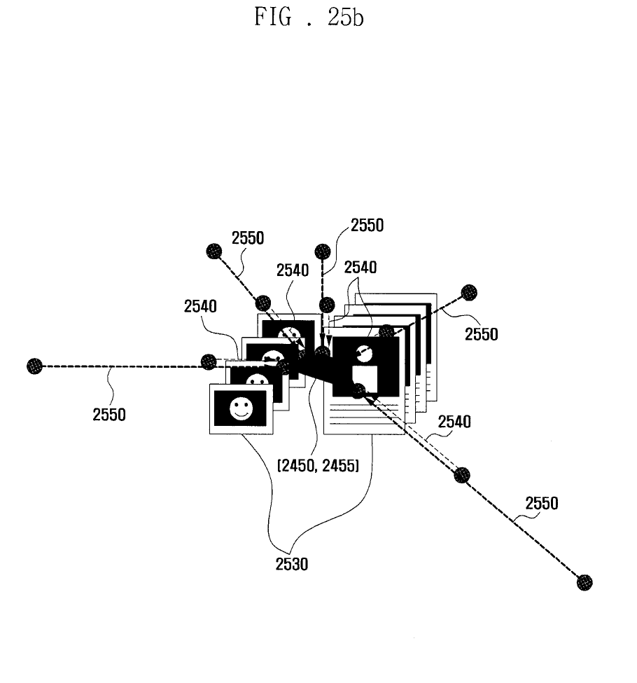

FIG. 25a and FIG. 25b illustrate a process for selecting an item according to an exemplary embodiment of the present invention.

Referring to FIG. 25a, user drags the touch sense area like the arrows 2510 in the situation where the selection area is in contact with the item like FIG. 24c, so that the size of a second selection area 2455 is decreased, and corresponding boundary positions move with other arrows 2520 as the touch sense area moves. It is assumed that the movement of boundary positions 2520 has the same direction as the movement of touch sense area 2510 and is in proportion to the movement distance. According to the movement of the boundary positions, the size of the first selection area 2450 is also decreased. If the size of the first selection area 2450 is decreased, the items 2530 contacted with the first selection area 2450 before decreasing the size contact with the first selection area 2450 in which the size is decreased, or is moved to locate within a first limitation distance (e.g., depending on setting by of one of user, touch interface manufacturer and software provider). In FIG. 24c, the items 2350 is in the state of contacting the first selection area 2450, and thereafter, since the size of the first selection area 2450 is decreased, the items 2530 contact with the first selection area 2450 in which the size is decreased, or are moved to locate in a smaller area from the first selection area 2450. In addition, the items 2530 can be displayed by one of grouping and sorting with respect to the same kind of item (e.g., document file type, and graphic file type).

Referring to FIG. 25b, user drags a touch sense area like the arrows 2540 in the state where a selection area contacts the item as illustrated in FIG. 24d, so that the size of a second selection area 2455 is decreased, and the corresponding boundary positions also move like other arrows 2550 according to movement of the touch sense area. It is assumed that the direction of movement 2550 of boundary positions is the same as the direction of movement 2540 of the corresponding touch sense area and is in proportion to the movement distance. According to the movement of the boundary positions, the size of the first selection area 2450 is also decreased. If the size of the first selection area 2450 is decreased, the items 2530 contacted with the first selection area 2450 before decreasing the size, one of contact with the first selection area 2450 in which the size is decreased, and is moved to a location within a first limitation distance (e.g., depending on setting by one of user, touch interface manufacturer and software provider). The items 2530 which are moved and displayed like FIG. 25a or FIG. 25b become the selected item and thereafter, move in association with the first selection area 2450.

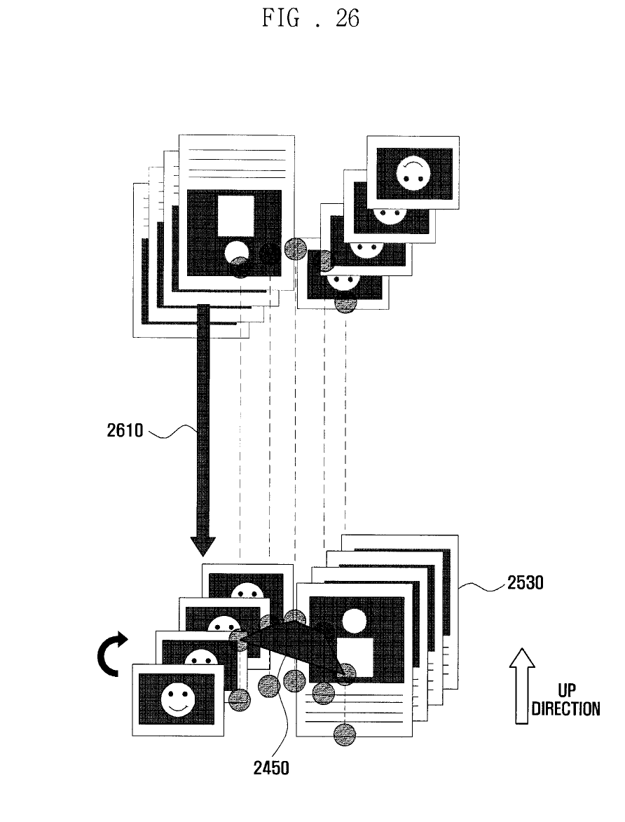

FIG. 26 illustrates a process for moving an item according to an exemplary embodiment of the present invention.

In case a first selection area 2450 moves in such a manner that a drag input is added to the touch sense area in a state where the item 2530 is selected as in FIG. 25a, accordingly, the item 2530 also moves in the movement direction. At this time, the item 2530 can be rotated and displayed so that the upper direction (top) of the item 2530 may turn toward the opposite direction of the movement direction 2610. It is advantageous in that user can see the item 2530 in a correct state.

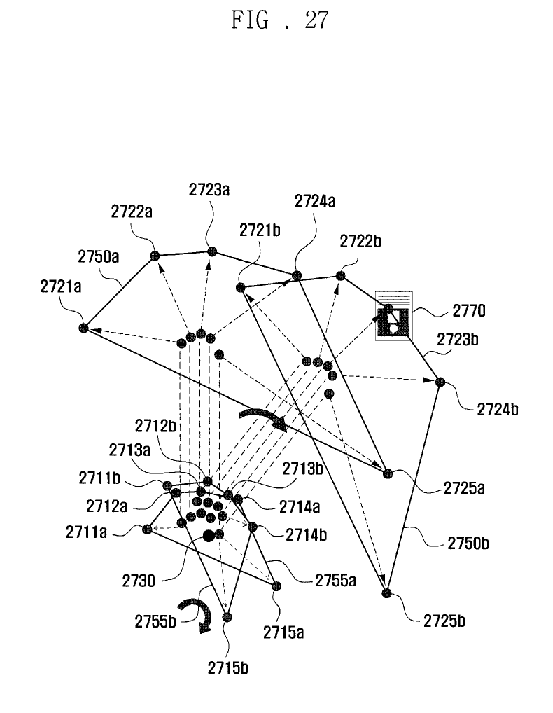

FIG. 27 illustrates a process for moving a selection area according to an exemplary embodiment of the present invention.

Referring to FIG. 27, a touch sense area exists at each of the positions of reference numerals 2711a, 2712a, 2713a, 2714a, 2715a, and a second selection area exists in a position of reference numeral 2755a. And also, a boundary position corresponding to the each touch sense area exists at the positions of reference numerals 2721a, 2722a, 2723a, 2724a, 2725a, and a first selection area exists at the position of reference numeral 2750a.

User drags the touch sense areas of reference numerals 2711a, 2712a, 2713a, 2714a, 2715a to the positions of reference numerals 2711b, 2712b, 2713b, 2714b, 2715b to move the second selection area from the position 2755a to the position of reference numeral 2755b. Here, it is assumed that the shape of the second selection area is almost maintained. That is, the variations of the distance between the touch sense areas is maintained within a second limitation distance, and variations of the angle between segments connecting the touch sense areas with each other are also maintained within a preset angle range. And, it is assumed that the touch sense area moves from respective positions of reference numerals 2711a, 2712a, 2713a, 2714a, 2715a of the touch sense area before movement while maintaining a certain distance from a virtual rotation axis 2730. That is, it is assumed that variations of distance from the rotation axis 2730 to each touch sense area are maintained within a third limitation distance. In this case, the touch interface recognizes the received touch input as a rotation input, rotates the first selection area with centering the rotation axis 2730 to move to the position 2750b, and to move the boundary positions of reference numerals 2721a, 2722a, 2723a, 2724a, 2725a to the positions of reference numerals 2721b, 2722b, 2723b, 2724b, 2725b. User can effectively move the selection area through the rotation interface.

According to another embodiment, while touch interface displays one of the rotation axis 2730 and a rotation mode button, the interface enter the rotation mode if user touches the rotation axis 2730 and rotation mode button, and analyzes the next input as an input rotating with centering on the rotation axis 2730, so that the interface can move the selection area as illustrated in FIG. 27.

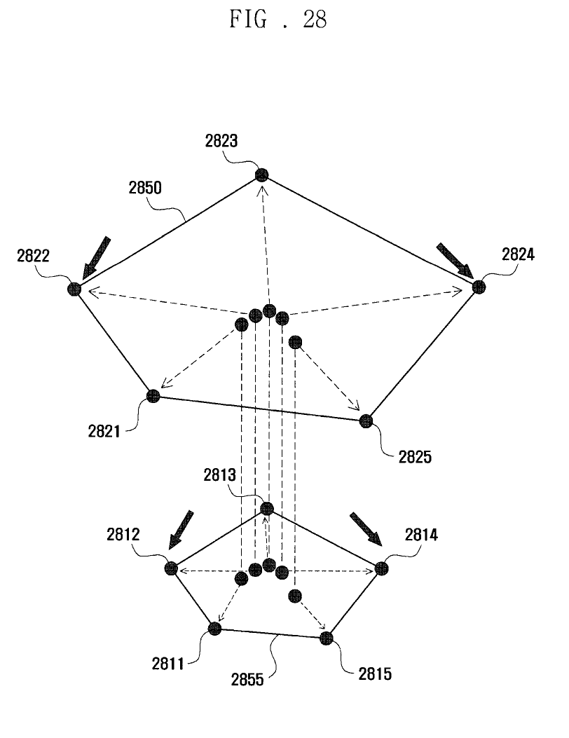

FIG. 28 illustrates a process for providing a touch interface according to an exemplary embodiment of the present invention.

According to user touch, a second selection area 2855 is displayed, which has a plurality touch sense areas 2811 to 2815 and an apex at each of the touch sense areas 2811 to 2815. A first selection area 2850 is displayed, which has a plurality of boundary positions 2821 to 2825 corresponding to the touch sense areas 2811 to 2815 and a boundary line including a plurality of boundary positions 2821 to 2825. In case of dragging a boundary area including the second boundary position 2822, a position of the second boundary position 2822 can be changed, and a shape of the first selection area 2850 can be changed. Additionally, the position of a second touch sense area corresponding to the second boundary position 2822 can be moved in proportion to the movement distance of the second boundary position 2822 in the same direction as movement direction of the second boundary position. Thus, the shape of the second selection area can be also changed. Further, by just dragging not only the touch sense areas 2811 to 2815 but also the circle of boundary areas centered on the boundary positions 2821 to 2825, a similar effect to the dragging of the touch sense areas 2811 to 2815 can be obtained.

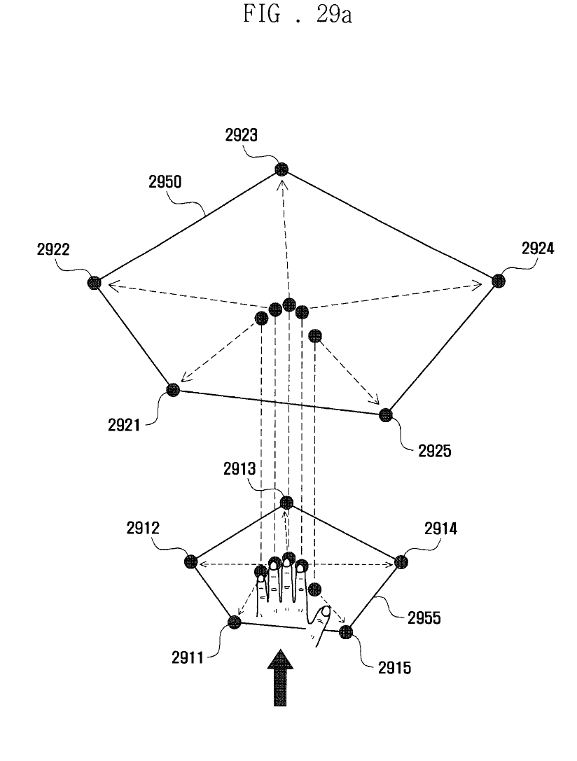

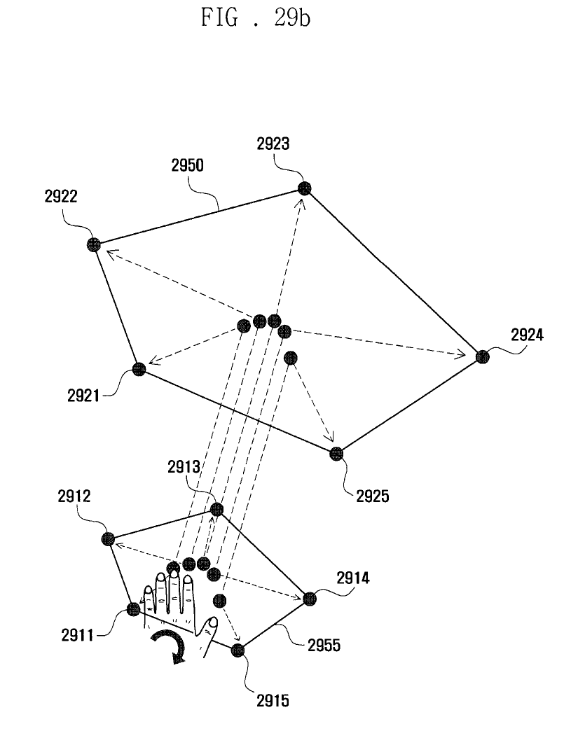

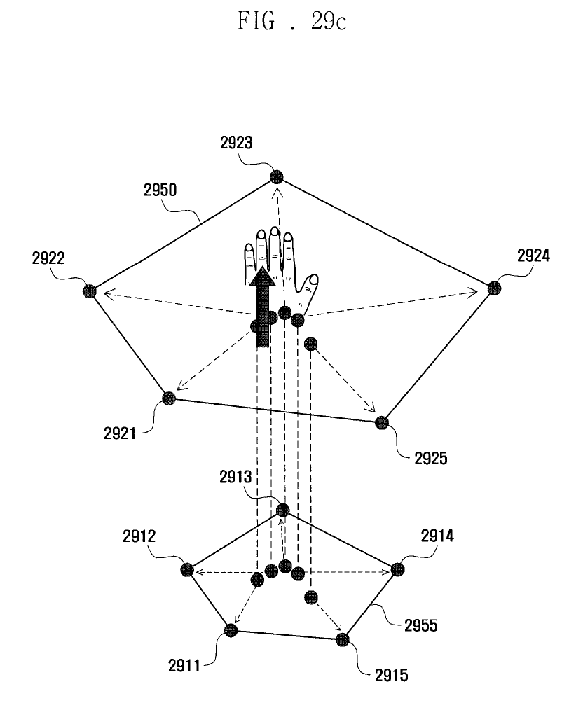

FIGS. 29a to 29c illustrates a process for providing a touch interface according to an exemplary embodiment of the present invention.

Referring to FIG. 29a and FIG. 29b, user can drag a second selection area 2955 surrounded by a plurality of touch sense areas 2911 to 2915. In this case, the shape and size of the second selection area 2955 can be maintained, while only the position and direction (in case of rotation) can be changed. In case the second selection area 2955 is moved and rotated according to the dragging of the second selection area 2955, the touch sense areas 2911 to 2915 included in a boundary line of the second selection area 2955 are moved in association with each other. And, as the touch sense areas 2911 to 2915 move, the boundary positions 2921 to 2925 and a first selection area 2950 are also rotated and displayed in one of the following ways in proportion to the movement distance of the touch sense areas 2911 to 2915, and by a same angle as the rotation angle of the touch sense areas 2911 to 2915, in the same direction as the direction of the moving and the rotating of the touch sense areas 2911 to 2915. In case of moving and rotating without any change of shape, dragging the second selection area itself may be more convenient.

Referring to FIG. 29c, user may drag directly the first selection area surrounded by the boundary areas 2921 to 2925. In this case, the second selection area 2955 cannot move associatively, but only the first selection area can move.

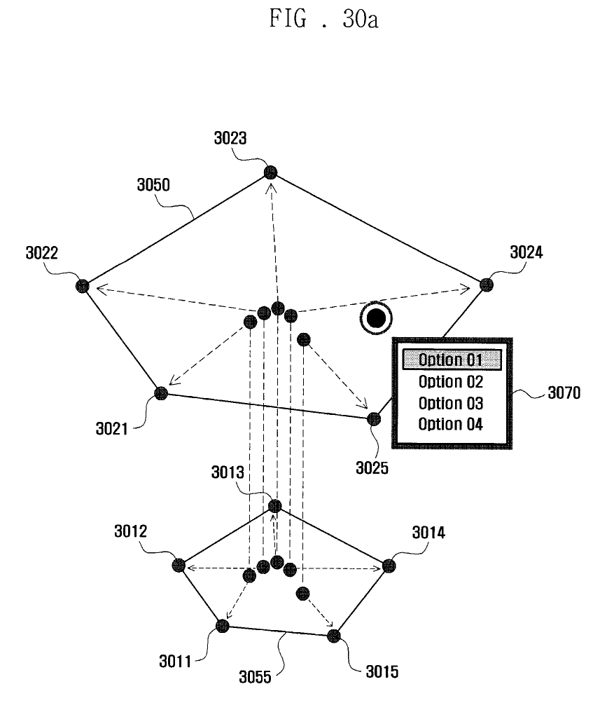

FIG. 30 illustrates a process for providing a touch interface according to an exemplary embodiment of the present invention.

A touch interface displays a second selection area 3055 which includes a plurality of touch sense areas 3011 to 3015 and a boundary line including the plurality of touch sense areas 3011 to 3015. In addition, the touch interface displays a plurality of boundary positions 3021 to 3025 corresponding to the touch sense areas 3011 to 3015, and displays a first selection area 3050 having a boundary line including the boundary positions 3021 to 3025. According to an exemplary embodiment of the present invention, in case a double click input is sensed in the first selection area 3050, an option window 3070 can be displayed.

According to another exemplary embodiment, at least one of the case where the double click input is sensed in the touch sense areas 3011 to 3015 depending on user's setting, the case where the double click input is sensed in the boundary areas including the boundary positions 3021 to 3025, and the case where the double click input is sensed in the second selection area 3055, the option window 3070 can be displayed. Commands which can be one of selected and executed in the option window 3070 are shown in Table 1.

TABLE 1

| DIVISION | CONTENTS |
|---|---|
| File information | Displaying information (thumbnail, or the like) of |
| display | selected item |
| Group arrangement | In case of grouping selected items, applying option |
| method | such as name order, shape order, date order, or |
| | the like |
| Send | Sending the grouped items to specific user |
| | (mail, network, or the like) |
| Erase | Erasing the selected item |
| Cancelation | Canceling the executed option |
| Quit | Altering to another touch interface mode |
| Additional setting | Duration time setting, transparency setting of |
| | selection area, existence and nonexistence of item |
| | snap (attaching in selection area), setting the |
| | proportion of the moving distance of selection area |
| | according to the moving distance of the touch |
| | sense area |

At this time, it can be understood that each illustration of flowcharts and the combination of the flowcharts can be executed by the instructions of a computer program. Since the instructions of the computer program can be loaded in the processor of any of a general purpose computer, a special purpose computer and other programmable data processing equipment, the instructions executed through one of the computer and the processor of the other programmable data processing equipment generates a means for processing the functions explained in the flowchart(s).

Since it is possible that these instructions of the computer program are also stored in a memory which can be one of used and be read in any of computer and other programmable data processing equipment which is compatible with the computer so as to implement the function in a specific manner, it is also possible for the instructions stored in the memory which can one of be used and be read in computer to manufacture a production which includes an instructing means executing the functions explained in blocks of the flowcharts.

Since it is possible that the instructions of the computer program can also be loaded in one of a computer and other programmable data processing equipment, it is also possible to provide the steps of executing the function explained in block(s) of the flowchart processes by instructions which generate a process executed in the computer by executing a series of operation steps on the one of the computer and other programmable data processing equipment.

In addition, each block may represent a module including one or more executable instructions for executing one of a specified logical function, a segment and a part of code. Further, it should be noted that, in some alternative embodiments, the functions mentioned in the blocks can be generated in wrong order. For example, it is also possible that the two blocks which are consecutively shown can be executed substantially at the same time, and that, sometimes, the blocks are executed in reverse order in accordance with a corresponding function.

At this time, the ‘˜unit’ used in the present exemplary embodiments means software or hardware element like FPGA or ASIC, and the ‘˜unit’ performs some roles. However, the ‘˜unit’ is not limited to software or hardware. The ‘˜unit’ can be configured to exist in an addressable storage medium, and can be configured to operate at least one processor.

Accordingly, as an example, the ‘˜unit’ comprises elements selected from the group consisting of software element, object oriented software elements, class elements and task elements, and further comprises processes, functions, attributes, procedures, subroutines, segments of program code, drivers, firmware, microcode, circuits, data, databases, data constructions, tables, arrays, and variations thereof. The function provided in elements and ‘˜unit’s can be any of coupled with more or less number of elements and the ‘˜unit’s, and divided into additional elements and ‘˜unit’s. In addition, elements and ‘˜unit’s can be implemented to operate at least one CPU in a device and a security multimedia card.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A method for providing an interface which is performed in a touch interface, the method comprising:
sensing a first touch input at a first position;
sensing a second touch input at a second position which is a different position from the first position while the first touch input is continuously sensed; and
displaying a selection area after sensing the first touch input and the second touch input.

2. The method of claim 1, wherein displaying a selection area further comprises:
displaying the selection area in a third position that is positioned on a straight line perpendicular to a segment which connects the first position with the second position in a middle point of the segment and is separately positioned from the middle point of the segment within a preset distance thereof.

3. The method of claim 1, wherein displaying a selection area further comprises:
displaying a selection area comprising a third position where a distance between the third position and the first position is a preset first distance, a distance between the third position and the second position is a preset second distance, and a ratio of the first distance to the second distance is set to be within a preset ratio range.

4. The method of claim 1, further comprising:
displaying a first area at the first position when the first touch input is sensed at the first position; and
displaying a second area at the second position when the second touch input is sensed at the second position.

5. The method of claim 4, further comprising:
fading out a display of at least one of the first area, the second area and the selection area, when the touch input is not sensed in any one of the first area and the second area.

6. The method of claim 5, further comprising:
clearly displaying at least one of the first area, the second area and the selection area when the touch input is sensed in one of the first area and the second area within a preset time in a state where the touch input is sensed in neither the first area nor the second area.

7. The method of claim 4, further comprising:
moving and displaying the first area and the second area to which a drag input is inputted to include a last point of the drag input in case the drag input is sensed in one of the first area and the second area is sensed.

8. The method of claim 7, further comprising:
moving the selection area to maintain a given angle which is formed by a first segment and a second segment in case the drag input in one of the first area and the second area is sensed, when the first segment connects a point where a last touch input is received on the first area with a point where a last touch input is received on the second area, and the second segment connects a middle point of the first segment with a third position at which the selection area is positioned.

9. The method of claim 7, further comprising:
changing the selection area so that a size of the selection area has one of a positive and a negative correlation with a length of a segment which connects a point where a last touch input is received on the first area with a point where a last touch input is received on the second area, when the drag input is sensed in one of the first area and the second area.

10. The method of claim 7, further comprising:
moving the selection area in a direction perpendicular to the first segment by a distance having a positive correlation with the movement distance, perpendicular to the first segment, of the middle point of the first segment connecting a point where a touch is lastly inputted in the first area with a point where a touch is lastly inputted in the second area, and displaying the moved selection area, when the drag input is sensed in one of the first area or the second area.

11. The method of claim 4, further comprising:
moving and displaying the selection area in association with an item, in case an input process for moving the selection area is sensed, after one of the touch input in the second area is started while one of all and some of the selection area is in contact with all or some of the item and the touch input in the first area is continued, and the touch input in the first area is started while one of all and some of the selection area is in contact with one of all and some of the item and the touch input in the second area is continued.

12. The method of claim 11, further comprising:
rotating the item so that the item is displayed in a direction opposite to a movement direction of the selection area, when the input process for moving the selection area is sensed.

13. The method of claim 1, further comprising:
moving the selection area in association with an item, when an input process for moving the selection area is sensed, after one of the item is dragged and dropped so that at least some of the selection area is in contact with at least some of the item, and the selection area is dragged and dropped so that at least some of the selection area is in contact with at least some of the item.

14. The method of claim 1, further comprising:
moving an item to a position within a preset distance from a segment connecting a point where a touch is lastly inputted at the first position with a point where a touch is lastly inputted at the second position, when one of the item is dragged and dropped so that at least some of the selection area is in contact with at least some of the item, and the selection area is dragged and dropped so that at least some of the selection area is in contact with at least some of the item.

15. The method of claim 1, further comprising:
moving an item and displaying the moved item when a flip input is sensed at a position of the item; and
moving the item to a position within a preset distance from a first segment, in case, during the movement of the item, the item is in contact with a second segment connecting a fourth position with a third position, the fourth position being included in the first segment connecting a point where a touch is lastly inputted at the first position with a point where a touch is lastly inputted in the second position, and the third position being included in the selection area.

16. The method of claim 1, further comprising:
moving an item and displaying the moved item when a flip input is sensed at a position of the item;
displaying the item while the item is in contact with a second segment, in case, during the movement of the item, the item is in contact with the second segment connecting a fourth position with a third position, the fourth position being included in a first segment connecting a point where a touch is lastly inputted at the first position with a point where a touch is lastly inputted at the second position, and the third position being included in the selection area; and
moving and displaying the selection area in association with the item.

17. The method of claim 4, further comprising:
moving and displaying an item to a fifth position when a flick input is sensed at any one of the first position and the second position, after the item is moved from the fifth position to a sixth position, depending on the flick input in the touch interface.

18. The method of claim 11, further comprising:
displaying an option window when a click input is sensed at one of the first position and the second position, after one of the click input at the second position is started while at least some of the selection area is in contact with at least some of the item and the touch input at the first position is continued, and the click input at the first position is started while at least some of the selection area is in contact with at least some of the item and the click input in the second position is continued.

19. A method for providing an interface which is performed in a touch interface, the method comprising:
sensing at least three touch inputs comprising a first touch input, a second touch input and a third touch input, wherein the first touch input is sensed at a first touch sensing position, the second touch input is sensed at a second touch sensing position, the third touch input is sensed at a third touch sensing position, and the first touch sensing position, the second touch sensing position and the third touch sensing position are arranged at different positions; and
displaying a first selection area surrounded by a boundary line comprising a first, second, and third boundary position which correspond to the first, second and third touch sensing position at which the respective first, second and third touch input is sensed.

20. The method of claim 19, further comprising:
displaying a first, second, and third touch sensing area comprising the first, second, and third touch sensing positions, respectively;
moving and displaying the first touch sensing area so that the first touch sensing area comprises a last point of a drag input when the drag input in the first touch sensing area is sensed; and
moving the first boundary position by a movement distance that is the same as the moving direction of the first touch sensing area and has a positive correlation with the movement distance of the first touch sensing area, and displaying the first selection area surrounded by a boundary line comprising the moved first boundary position.

21. The method of claim 19, further comprising:
moving and displaying at least one item, so that one of the at least one item which contacted the first selection area prior to a decrease in size thereof, is in contact with the first selection area, and the at least one item is arranged within a preset distance from the first selection area whose size is decreased, when the first selection area is decreased in size.

22. The method of claim 19, further comprising:
displaying the first, second, and third touch sensing area comprising the first, second, and third touch sensing position, respectively;
moving and displaying the first touch sensing area so that the first touch sensing area comprises the last point of a drag input, in case the drag input in the first touch sensing area where a variation of the distances between the first, second, and third touch sensing areas are within a second limitation distance and a variation of the distances from a rotation axis to the first, second, and third touch sensing area are within a third limitation distance, is sensed;
rotating and displaying the first, second, and third boundary position, respectively, by the same angle as a rotation angle of the first, second and third touch sensing area from the rotation axis in the same direction as the rotation direction of the first, second, and third touch sensing area; and
displaying the first selection area surrounded by a boundary line comprising one of the moved and rotated first boundary position.

23. The method of claim 19, further comprising:
moving and displaying the first boundary position so that first boundary position comprises the last point of a drag input in case the drag input at the first boundary position is sensed;
displaying the first selection area surrounded by a boundary line comprising the moved first boundary position; and
moving and displaying the first touch sensing position which corresponds to the first boundary position by a movement distance that is the same as the moving direction of the first boundary position and has a positive correlation with the movement distance of the first boundary position.

24. The method of claim 19, further comprising:
moving and displaying the first selection area to correspond to a drag input in case the drag input in the second selection area, which is surrounded by a boundary line comprising the first, second, and third touch sensing position, is sensed.

25. The method of claim 19, further comprising:
displaying an option window when a double click input is sensed in any one of the first, second, and third touch sensing positions.
